(19) United States
(12) Patent Application Publication
(10) Pub. No.: US 2025/0254045 A1
(43) Pub. Date: Aug. 7, 2025

(54) METHOD FOR PERFORMING ENCRYPTION DETECTION ON COMMUNICATION DATA BASED ON MACHINE LEARNING, AND RELATED DEVICE

(71) Applicant: TENCENT TECHNOLOGY (SHENZHEN) COMPANY LIMITED, Shenzhen (CN)

(72) Inventors: Qing YANG, Shenzhen (CN); Jie FU, Shenzhen (CN); Jinglun LI, Shenzhen (CN)

(21) Appl. No.: 19/184,976

(22) Filed: Apr. 21, 2025

Related U.S. Application Data
(63) Continuation of application No. PCT/CN2024/085599, filed on Apr. 2, 2024.

(30) Foreign Application Priority Data
Apr. 14, 2023 (CN) 202310402842.9

(51) Int. Cl. H04L 9/32

(52) U.S. Cl. CPC H04L 9/32

(57) ABSTRACT

An encryption detection method includes performing a pre-analysis on a possibility of communication data being encrypted to obtain a pre-analysis result, calling, in response to the pre-analysis result indicating that the possibility is greater than a preset possibility threshold, a data encryption discriminative model to extract a data feature from the communication data, searching in a discriminative feature library for a matching prestored discriminative feature that matches the data feature based on a feature value of the data feature and discriminative feature values of a plurality of prestored discriminative features in the discriminative feature library, and determining, in response to the matching prestored discriminative feature being found, that the communication data is encrypted.

### CROSS-REFERENCE TO RELATED APPLICATIONS

This application is a continuation of International Application No. PCT/CN2024/085599, filed on Apr. 2, 2024, which claims priority to Chinese Patent Application No. 2023104028429, filed with the China National Intellectual Property Administration on Apr. 14, 2023 and entitled “METHOD FOR PERFORMING ENCRYPTION DETECTION ON COMMUNICATION DATA BASED ON MACHINE LEARNING, AND RELATED DEVICE,” the entire contents of both of which are incorporated herein by reference.

### FIELD OF THE TECHNOLOGY

This application relates to the technical field of computers, and in particular, to a method for performing encryption detection on communication data based on machine learning, an apparatus for performing encryption detection on communication data based on machine learning, a computer device, and a computer-readable storage medium.

### BACKGROUND OF THE DISCLOSURE

As Internet technologies develop, data transmission based on the Internet imposes increasingly high requirements on security. In order to ensure security of data transmission, data is generally required to be encrypted before transmitted. However, encryption mechanisms for communication data may be not perfect enough according to some communication standards. As a result, there exists a case of unencrypted communication data, which brings some data safety hazards. Thus, it is essential to perform encryption detection on the communication data.

However, because a current method for performing encryption detection on communication data offers single analysis on the communication data, there is still room for improvement in corresponding effectiveness of the encryption detection on the communication data.

### SUMMARY

In accordance with the disclosure, there is provided an encryption detection method including performing a pre-analysis on a possibility of communication data being encrypted to obtain a pre-analysis result, calling, in response to the pre-analysis result indicating that the possibility is greater than a preset possibility threshold, a data encryption discriminative model to extract a data feature from the communication data, searching in a discriminative feature library for a matching prestored discriminative feature that matches the data feature based on a feature value of the data feature and discriminative feature values of a plurality of prestored discriminative features in the discriminative feature library, and determining, in response to the matching prestored discriminative feature being found, that the communication data is encrypted.

Also in accordance with the disclosure, there is provided a computer device including a processor, and a non-transitory computer-readable storage medium storing a computer program that, when executed by the processor, causes the processor to perform a pre-analysis on a possibility of communication data being encrypted to obtain a pre-analysis result, call, in response to the pre-analysis result indicating that the possibility is greater than a preset possibility threshold, a data encryption discriminative model to extract a data feature from the communication data, search in a discriminative feature library for a matching prestored discriminative feature that matches the data feature based on a feature value of the data feature and discriminative feature values of a plurality of prestored discriminative features in the discriminative feature library, and determine, in response to the matching prestored discriminative feature being found, that the communication data is encrypted.

Also in accordance with the disclosure, there is provided a non-transitory computer-readable storage medium storing a computer program stored that, when executed by a processor, causes the processor to perform a pre-analysis on a possibility of communication data being encrypted to obtain a pre-analysis result, call, in response to the pre-analysis result indicating that the possibility is greater than a preset possibility threshold, a data encryption discriminative model to extract a data feature from the communication data, search in a discriminative feature library for a matching prestored discriminative feature that matches the data feature based on a feature value of the data feature and discriminative feature values of a plurality of prestored discriminative features in the discriminative feature library, and determine, in response to the matching prestored discriminative feature being found, that the communication data is encrypted.

### BRIEF DESCRIPTION OF THE DRAWINGS

FIG. 1A is an architecture diagram of a system for performing encryption detection on communication data based on machine learning according to an embodiment of this application;

FIG. 1B is a schematic diagram of an application scenario of performing encryption detection on communication data based on machine learning according to an embodiment of this application;

FIG. 2 is a schematic flowchart of a method for performing encryption detection on communication data based on machine learning according to an embodiment of this application;

FIG. 3 is a schematic flowchart of another method for performing encryption detection on communication data based on machine learning according to an embodiment of this application;

FIG. 4A is a schematic diagram of a data encapsulation format of satellite communication data at various layers according to an embodiment of this application;

FIG. 4B is a schematic diagram showing that useless data exists in satellite communication data according to an embodiment of this application;

FIG. 5A is a schematic diagram of constructing a discriminative feature library according to an embodiment of this application;

FIG. 5B is a schematic diagram of outputting a discrimination result according to an embodiment of this application;

FIG. 6A is a framework diagram of processing communication data based on machine learning according to an embodiment of this application;

FIG. 6B is a schematic flowchart of processing communication data based on machine learning according to an embodiment of this application;

FIG. 7 is a schematic structural diagram of an apparatus for performing encryption detection on communication data based on machine learning according to an embodiment of this application; and

FIG. 8 is a schematic structural diagram of a computer device according to an embodiment of this application.

### DESCRIPTION OF EMBODIMENTS

Technical solutions in embodiments of this application will be clearly and completely described below in combination with accompanying drawings in the embodiments of this application. Apparently, the described embodiments are merely some embodiments rather than all embodiments of this application. All other embodiments obtained by a person of ordinary skill in the art based on the embodiments of this application without creative efforts shall all fall within the scope of protection of this application. In this application, the term “at least one” means one or more, and “plurality of” means two or more. For example, at least one piece of encrypted communication sample data refers to one piece of encrypted communication sample data, or two or more pieces of encrypted communication sample data. A plurality of prestored discriminative features refer to two or more prestored discriminative features.

This application provides a solution for performing encryption detection on communication data based on machine learning. The so-called encryption detection means that whether the communication data is encrypted data is detected. The encrypted data refers to data obtained after encryption. The solution relates to a system for performing encryption detection on communication data based on machine learning, a method for performing encryption detection on communication data based on machine learning, and a related device. In the solution, in a case of to-be-processed communication data, a pre-analysis is first performed on a possibility (that is, an encryption possibility) that the communication data is encrypted data. In a case that a pre-analysis result indicates that the possibility (that is, the encryption possibility) that the communication data is encrypted data is relatively high, data feature extraction may be performed on the communication data by a data encryption discriminative model. Based on a feature value of an extracted data feature and a feature value of each prestored discriminative feature in a discriminative feature library, a matching prestored discriminative feature of the data feature is searched for in a discriminative feature library. Further, the communication data is determined to be encrypted data when the matching prestored discriminative feature of the data feature is found. In this way, a multi-dimensional analysis can be performed on the communication data. A level of the possibility that the communication data is encrypted data can be determined through the pre-analysis. Moreover, the communication data is further analyzed in combination with the data encryption discriminative model. Thus, encrypted data can be more accurately determined. Through the solution, some unencrypted data having relatively large randomness can be effectively prevented from being mistakenly determined to be encrypted data. Thus, effectiveness of performing the encryption detection on the communication data can be improved. Moreover, in a scenario of encryption detection on massive communication data, communication data having a relatively high encryption possibility is selected through an encryption analysis, and the communication data having a relatively high encryption possibility is more accurately determined. Thus, not only overall detection efficiency can be improved, but also accuracy of determining encrypted data can be ensured.

The solution for performing encryption detection on communication data based on machine learning provided in this application may be applied to various service scenarios, including but not limited to: (1) a data communication scenario in the communication field having a relatively high requirement on data security, such as a financial data exchange scenario; (2) a scenario in which whether data is encrypted is required to be rapidly determined, such as a data security audit scenario and a network security detection scenario; and (3) a scenario in which an encrypted data analysis is required, such as a data security research scenario and a data security analysis scenario. Further, based on determining whether the communication data is encrypted data, when the communication data is encrypted data, content such as encryption strength of the encrypted data can be further determined. Further, whether the communication data can be securely transmitted can be determined. Thus, the solution for performing encryption detection on communication data based on machine learning may be further applied to: (4) a scenario based on information transmission security of a current communication system being required to be evaluated; (5) a scenario in which security of a current communication system is required to be strengthened; and (6) another scenario in which encryption detection on data is required.

The communication system mentioned above may be a satellite communication system. In the solution, based on a pre-analysis on communication data, a level of an encryption possibility of the communication data can be determined. A data encryption discriminative model is called to perform feature extraction on communication data having a relatively high encryption possibility. Whether a matching prestored discriminative feature of the data feature exists in a discriminative feature library is detected according to a feature value of the extracted data feature. Finally, whether the communication data is encrypted is determined. Based on a processing capacity of the data encryption discriminative model, when complex computation and analysis are required to be performed on the communication data, the complex computation and analysis can be implemented in a relatively short time. Thus, a result indicating whether the communication data is encrypted can be obtained, and efficiency of the encryption detection can be improved.

An architecture of a system for performing encryption detection on communication data based on machine learning provided in an embodiment of this application will be introduced below in combination with accompanying drawings.

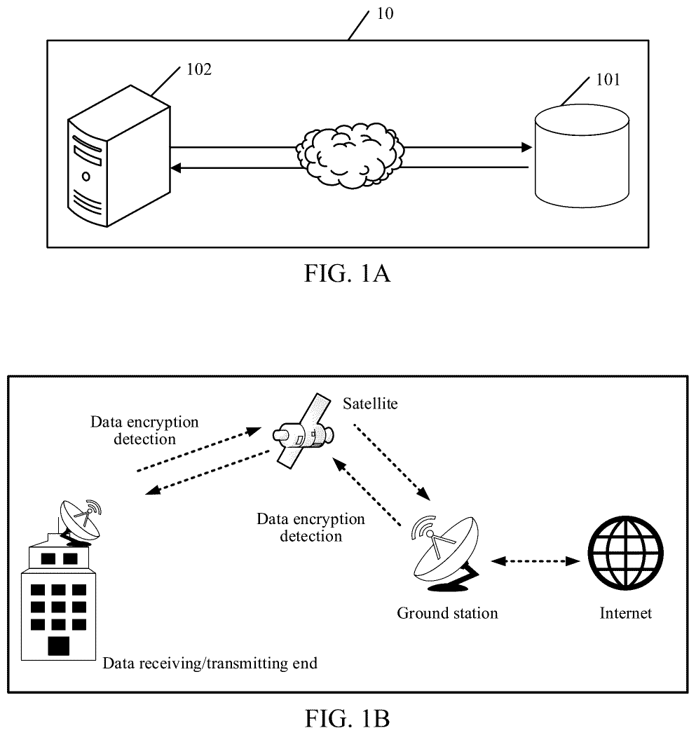

With reference to FIG. 1A, an architecture diagram of a system for performing encryption detection on communication data based on machine learning according to an exemplary embodiment of this application is shown. As shown in FIG. 1A, the system 10 for performing encryption detection on communication data based on machine learning includes a database 101 and a computer device 102. A communication connection may be established between the database 101 and the computer device 102 through a wired or wireless method. The computer device 102 is configured to perform a flow of performing encryption detection on communication data based on machine learning. The database 101 is configured to provide data support for a process of performing encryption detection on communication data based on machine learning of the computer device 102.

The computer device 102 may be a terminal device or a server. The terminal device includes but is not limited to: a smartphone, a tablet computer, an intelligent wearable device, an intelligent speech interaction device, an intelligent appliance, a personal computer, an on board terminal, an intelligent camera, and other devices, and is not limited in this application. A quantity of terminal devices is not limited in this application. The server may be an independent physical server, a server cluster or distributed system composed of a plurality of physical servers, or a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform, but is not limited thereto. A quantity of servers is not limited in this application.

Division is performed according to deployment positions. The database 101 may be a local database of the computer device 102, or may be a cloud database that can establish a connection to the computer device 102. To-be-processed communication data may be stored in the database 101. The communication data may be data transmitted based on a communication standard, such as data transmitted by using satellite communication standards DVB-S/S2/S2X (a series of digital satellite communication standards mainly configured for providing high-quality digital video and data transmission services in the field of satellite communication). The data includes but is not limited to: video data, audio data, image data, document data, etc. Further, a pre-trained data encryption discriminative model may be also stored in the database 101. When the computer device is required to detect encrypted data, whether the communication data is encrypted data may be determined by the data encryption discriminative model.

The flow of performing encryption detection on communication data based on machine learning performed by the computer device 102 may roughly include: (1) Determine a level of an encryption possibility of the communication data. (2) Call the data encryption discriminative model to extract a data feature of the communication data. (3) Search for, based on a feature value of the data feature and a feature value of each prestored discriminative feature in a discriminative feature library, in the discriminative feature library, a matching prestored discriminative feature of the data feature. (4) Determine, based on a search result, whether the communication data is encrypted data.
(1) Determine a level of an encryption possibility of the communication data.

The communication data may be obtained from the database 101 or other computer devices. The communication data includes but is not limited to any one type of: video data, audio data, image data, document data, database data, protocol data, webpage data, etc. By performing a pre-analysis on the communication data, a level of an encryption possibility of the communication data (that is, a level of a possibility that the communication data is encrypted data) can be determined based on a pre-analysis result. In an embodiment, the pre-analysis may be implemented based on a comparison between information entropy of the communication data and an entropy threshold, or may be implemented based on another feature of the communication data. The another feature of the communication data is whether the communication data includes, for example, identification information obtained after encryption, a file header added during encryption, etc. This is not limited in this application.
(2) Call the data encryption discriminative model to extract a data feature of the communication data.

When it is determined, based on the pre-analysis result, that the encryption possibility of the communication data is relatively high, the data encryption discriminative model may be called to perform data feature extraction on the communication data, such that a data feature of the communication data is obtained. Whether the communication data is encrypted data may be finally determined based on the data feature. The data encryption discriminative model may be obtained from the database 101, another database, or a computer device. This is not limited in this application.
(3) Search, based on a feature value of the data feature and a feature value of each prestored discriminative feature in a discriminative feature library, in the discriminative feature library, for a prestored discriminative feature matching the data feature, also referred to as a “matching prestored discriminative feature” of the data feature.

In a practicable method, the discriminative feature library includes a plurality of prestored discriminative features. The prestored discriminative features included in the discriminative feature library are all data features of encrypted communication data. Thus, whether the communication data is encrypted data can be finally determined by comparing feature values.
(4) Determine, based on a search result, whether the communication data is encrypted data.

When the search result indicates that the matching prestored discriminative feature of the data feature is found in the discriminative feature library, a prestored discriminative feature similar to the data feature of the communication data exists in the discriminative feature library. Further, the communication data can be determined to be encrypted data. Moreover, an encryption method for the communication data is the same as an encryption method corresponding to the prestored discriminative feature. The above matching means, for example, that a difference between a feature value of the prestored discriminative feature and a feature value of the data feature is less than a threshold.

In an implementable method, when the search result indicates that no matching prestored discriminative feature of the data feature is found in the discriminative feature library, the communication data can be determined to be unencrypted data, i.e., the communication data can be determined to be unencrypted. Based on comparing features values of data features of various types of encrypted communication data included in the discriminative feature library with the feature value of the data feature of the communication data, whether each piece of communication data subjected to different encryption (such as different processing brought by different encryption methods) is encrypted can be relatively accurately determined. Mistaken determination can be reduced as much as possible, and an accuracy rate of encryption detection can be improved.

According to the method for performing encryption detection on communication data based on machine learning provided in this application, by performing the pre-analysis on the communication data, a level of an encryption possibility of the communication data can be determined. In a case of communication data having a relatively high encryption possibility, further encryption discrimination may be performed by a data encryption discriminative model. Thus, unencrypted data can be prevented from being mistakenly determined to be encrypted data. In a process of using the data encryption discriminative model for encryption discrimination, feature extraction may be performed first. Then, by using a feature value of the extracted data feature and a feature value of each prestored discriminative feature in the discriminative feature library, a matching prestored discriminative feature of the data feature is searched for in the discriminative feature library. Whether the communication data is encrypted data can be finally determined through an indication of a search result. Based on training of the data encryption discriminative model and different prestored discriminative features in the discriminative feature library, data encryption detection can be more effectively performed. Based on improvement of corresponding effectiveness of the encryption detection on the communication data, security of data transmission can be ensured.

During actual application, the solution provided in this application may be performed before the communication data is transmitted or when the communication data is transmitted. Whether the communication data is encrypted can be detected based on the solution. If the communication data is encrypted data, encryption strength of the communication data may be further analyzed. Moreover, when the encryption strength does not satisfy a transmission security condition, security of the communication data can be strengthened by using higher encryption strength. If the communication data is unencrypted data, the communication data may be intercepted, and transmitted after encryption. In this way, assistance can be offered to an evaluation on security of data transmission, and a hidden safety hazard of the communication data can be found in time.

Illustratively, reference can be made to an application scenario of performing encryption detection on communication data based on machine learning shown in FIG. 1B. The communication data is, for example, data transmitted based on a series of satellite communication standards DVB-S/S2/S2X. Specifically, DVB-S/S2/S2X may be configured for transmitting a digital television signal between a satellite and the ground by means of an electromagnetic wave. Since the electromagnetic wave is completely exposed, satellite communication data can be completely obtained from an air interface side through a technical means. Moreover, DVB-S/S2/S2X series of protocols are transmission protocols of digital satellite communication, are only responsible for encoding or decoding transmission data, and do not encrypt data. An object (which may transmit or receive satellite communication data) using satellite communication carries plenty of important services. When satellite communication is performed by using DVB-S/S2/S2X protocols, before communication data is transmitted to a ground station through a satellite, encryption detection on communication data may be performed through a solution provided in this application. Thus, it can be ensured that the communication data is encrypted before being transmitted to the ground station by the satellite. In addition, before the ground station transmits, through a satellite, communication data transmitted from the Internet to an object using a satellite communication system, or before the communication data is transmitted from the Internet to the ground station, data encryption detection may be performed according to the solution provided in this application. Thus, it can be ensured that the communication data is encrypted before transmitted. In this way, even if an attacker sets up a satellite ground receiving station, a possibility that the attacker intercepts unencrypted satellite communication data can be reduced. Data leakage can be avoided, and security of data transmission can be ensured.

A method for performing encryption detection on communication data based on machine learning provided in an embodiment of this application will be introduced next.

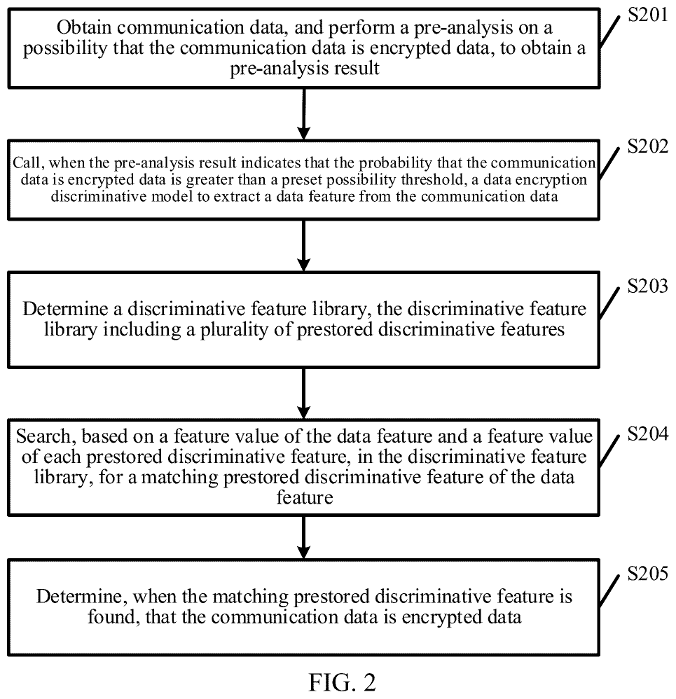

With reference to FIG. 2, a schematic flowchart of a method for performing encryption detection on communication data based on machine learning according to an embodiment of this application is shown. The method for performing encryption detection on communication data based on machine learning may be performed by a computer device (such as the computer device in the system shown in FIG. 1A). The method for performing encryption detection on communication data based on machine learning may include following S201 to S205.

S201: Obtain the communication data, perform a pre-analysis on a possibility that the communication data is encrypted data, and obtain a pre-analysis result.

The communication data mentioned herein refers to communication data to be subjected to encryption detection. The communication data may be data required to be encrypted before transmitted. According to different communication methods, the communication data includes but is not limited to: satellite communication data, optical fiber communication data, etc. The satellite communication data is digital signal data transmitted between a satellite and the ground by means of an electromagnetic wave, and may be transmitted based on a corresponding satellite communication standard (such as a series of digital satellite communication standards DVB-S/S2/S2X). The optical fiber communication data is digital signal data transmitted based on an optical fiber. According to different data content, the communication data includes but is not limited to: multimedia data (such as audio, video, and a picture), document data (such as Word, Excel, and TXT), protocol data, database data (such as a database file), webpage data (such as a webpage file), etc. In addition, the communication data is data required to be encrypted before transmitted. By performing encryption detection on the communication data, it can be ensured that content included in the communication data is encrypted before transmitted.

In order to balance a plenty of aspects such as effectiveness of encryption detection, a resource used for encryption detection, and a speed of encryption detection on communication data, a pre-analysis may be first performed on a possibility that the communication data is encrypted data, and a pre-analysis result is obtained.

In an embodiment, a discriminative feature of the communication data may be obtained. Based on the discriminative feature, a pre-analysis is performed on a possibility that the communication data is encrypted data, and a pre-analysis result is obtained. The discriminative feature of the communication data includes but is not limited to one or more types of: information entropy, information added during encryption, a data length, a data storage or transmission structure, other tiny features, etc. The reasons why the above initial discriminative feature can be configured for initially discriminating a level of a possibility of communication data are as follows: (1) After data is encrypted, some special file headers or other identification information may be added to an encryption result based on an encryption algorithm such that a decryption algorithm can correctly identify the encryption algorithm and decrypted data. Thus, information added during encryption can be taken as an initial discriminative feature. (2) When original data is encrypted, the encryption algorithm may fill some particular lengths. Thus, the data length can be also taken as an initial discriminative feature. (3) In a case of unencrypted data, a method for storing data may be identified according to some common data storage and transmission structures. Thus, the data storage or transmission structure may be also taken as a data feature. (4) Since encryption and compression can change information entropy of data, the information entropy may be also taken as a significant initial discriminative feature. (5) Other tiny features are provided. These features can extremely improve, in cases of hybrid matching and mutual reference, an accuracy rate of initially discriminating that the communication data is encrypted data. In some embodiments, the communication data may be transmitted as a data stream, such as a video stream and an audio stream. Whether a data stream is encrypted can be more accurately determined by combining a plurality of types of features. If the above features are not taken as initial discriminative features, the above features may be taken as data features extracted by the data encryption discriminative model for subsequent processing.

The pre-analysis result may indicate a level of a possibility that the communication data is encrypted data. When the pre-analysis result indicates that the possibility that the communication data is encrypted data is greater than a preset possibility threshold, the pre-analysis result indicates that the possibility that the communication data is encrypted data is relatively high. This indicates that the possibility that the communication data is encrypted is relatively high. Thus, content shown in S202 to S205 may be further performed.

In an embodiment, when the pre-analysis result indicates that the possibility that the communication data is unencrypted data is greater than a preset possibility threshold, the communication data is directly determined to be unencrypted data. Specifically, the situation that the possibility that the communication data is unencrypted data is greater than the preset possibility threshold may be understood as a situation that the possibility that the communication data is encrypted data is less than or equal to the preset possibility threshold. That is, the possibility that the communication data is unencrypted data is relatively high. In this case, content shown in S202 to S205 are not required to be performed. The communication data can be directly determined to be unencrypted data. That is, the communication data is not encrypted. In an implementable method, when the communication data is determined to be unencrypted data, the communication data may be intercepted, and is encrypted before transmitted.

When massive to-be-processed communication data exists, by performing a pre-analysis on the possibility that each piece of communication data is encrypted data, communication data having a relatively high encryption possibility can be rapidly selected. Then, the communication data having a relatively high encryption possibility is further analyzed by the data encryption discriminative model. Thus, efficiency of the encryption detection can be improved. In addition, due to the data encryption discriminative model, a situation that unencrypted data is mistakenly determined to be encrypted data can be reduced. An overall accuracy rate of detecting encrypted data can be improved.

S202: Call, when the pre-analysis result indicates that the possibility that the communication data is encrypted data is greater than a preset possibility threshold, a data encryption discriminative model to extract a data feature from the communication data.

The data encryption discriminative model is a trained discriminative model obtained based on machine learning, and may be configured to determine whether the communication data is encrypted data. Through training based on machine learning, according to provided input data (that is, the communication data herein), a computer device can more accurately predict a result (that is, predict whether the communication data is encrypted).

The data encryption discriminative model is called to perform data feature extraction on the communication data such that a data feature of the communication data can be obtained. Whether the communication data is encrypted can be finally determined by using the data feature. Based on a feature that the communication data is a digital signal, the data feature of the communication data may include one or more types of: a time-domain feature and a frequency-domain feature. The time-domain feature is, for example, some statistics (such as an average, a variance, and a correlation coefficient). The frequency-domain feature is, for example, a feature of a frequency domain dimension obtained through Fourier transformation or wavelet transformation. In another implementation, the data feature may represent one or more types of: whether the communication data includes information added during encryption, a length of the communication data, a data storage and transmission structure of the communication data, etc. The data feature is different from an initial discriminative feature used for initial discrimination. Whether the communication data is encrypted can be more accurately determined based on the data feature.

S203: Determine a discriminative feature library.

The data encryption discriminative model includes the discriminative feature library. The discriminative feature library includes a plurality of prestored discriminative features. One prestored discriminative feature is a data feature of one piece of encrypted communication data, and may represent that the encrypted communication data is encrypted. That is, all prestored discriminative features in the discriminative feature library are data features of all pieces of encrypted communication data. One prestored discriminative feature may correspond to one encryption method. The encrypted communication data, that is, encrypted communication data, may be encrypted communication sample data configured for training and obtaining the data encryption discriminative model, or may be other encrypted communication data. In cases of prestored discriminative features corresponding to any two pieces of encrypted communication data in the discriminative feature library, when encryption methods of the any two pieces of encrypted communication data are different, prestored discriminative features corresponding to the any two pieces of encrypted communication data are different. For example, in a case of the same unencrypted data, encrypted communication data A1 can be obtained by performing encryption through an encryption method 1, and encrypted communication data A2 can be obtained by performing encryption through an encryption method 2. Since the encryption methods are different, a discriminative feature corresponding to the encrypted communication data A1 and a discriminative feature corresponding to the encrypted communication data A2 are different. The prestored discriminative features in the discriminative feature library may be classified and stored through different encryption methods or according to different encryption strength. The encryption strength may depend on an encryption method used for encryption and a level of complexity of a secret key.

S204: Search, based on a feature value of the data feature and a feature value of each prestored discriminative feature, in the discriminative feature library, for a matching prestored discriminative feature of the data feature.

The data feature of the communication data and prestored discriminative features in the discriminative feature library all have corresponding feature values. In an implementable method, hit detection herein may specifically include: compare the feature value of the data feature with the feature value of each prestored discriminative feature in the discriminative feature library, and search for, by comparing the feature values, the matching prestored discriminative feature of the data feature in the discriminative feature library.

S205: Determine, when the matching prestored discriminative feature is found, that the communication data is encrypted data, i.e., that the communication data is encrypted.

When the matching prestored discriminative feature of the data feature is found, a prestored discriminative feature of which a feature value matches the feature value of the data feature exists in the discriminative feature library. Based on a feature that corresponding feature values in the same encryption method match, the communication data can be determined to be encrypted data obtained after encryption. That is, the communication data is encrypted.

As a practicable implementation, one prestored discriminative feature in the discriminative feature library corresponds to one encryption method. A specific implementation of S204 may include: Determine, when the matching prestored discriminative feature is found, that the communication data is obtained through an encryption method corresponding to the matching prestored discriminative feature, and determine that the communication data is encrypted data. Namely, based on an indication of a search result, it can be first determined that the same encryption method is used for the communication data and the encrypted communication data corresponding to the matching prestored discriminative feature of the data feature. Further, the communication data is determined to be encrypted data. Through a method of first determining the encryption method and then determining that the communication data is encrypted data, the detection result that the communication data is encrypted data is more well-founded. Thus, credibility of the detection result can be improved.

In an embodiment, when no matching prestored discriminative feature of the data feature is found, the communication data is determined to be unencrypted data. Specifically, based on an indication of a search result, when no prestored discriminative feature of which the feature value matches the feature value of the data feature exists in the discriminative feature library, the communication data can be further determined to be unencrypted data. That is, the communication data is not encrypted.

In an embodiment of this application, the communication data may be obtained. A pre-analysis is performed on a possibility that the communication data is encrypted data. A pre-analysis result is obtained. A level of the possibility that the communication data is encrypted data can be determined through the pre-analysis. Further, whether the communication data is encrypted data can be initially discriminated. When the pre-analysis result indicates that the possibility that the communication data is encrypted data is greater than a preset possibility threshold, a data encryption discriminative model may be called to extract a data feature from the communication data. Next, based on a feature value of the data feature and a feature value of each prestored discriminative feature, a matching prestored discriminative feature of the data feature may be searched for in the discriminative feature library. Moreover, when the matching prestored discriminative feature of the data feature is found, the communication data can be determined to be encrypted data. In the above processing process, the pre-analysis, data feature extraction, etc. may be sequentially performed on the possibility that the communication data is encrypted data. Then, matching is performed according to the feature value of the data feature and the feature value of the prestored discriminative feature. Finally, whether the communication data is encrypted is determined. In this way, a multi-dimensional analysis can be implemented on the communication data such that encrypted data can be relatively accurately determined. An accuracy rate of detecting whether the communication data is encrypted can be improved. Further, effectiveness of performing the encryption detection on the communication data can be improved. In a scenario of performing encryption detection on massive communication data, communication data having a relatively high encryption possibility is selected by determining an encryption possibility of the communication data. Then, in a case of the communication data having a relatively high encryption possibility, encrypted data is finally determined by a data encryption discriminative model. In this way, overall efficiency of detecting whether the communication data is encrypted can be improved, and effectiveness of the encryption detection can be ensured.

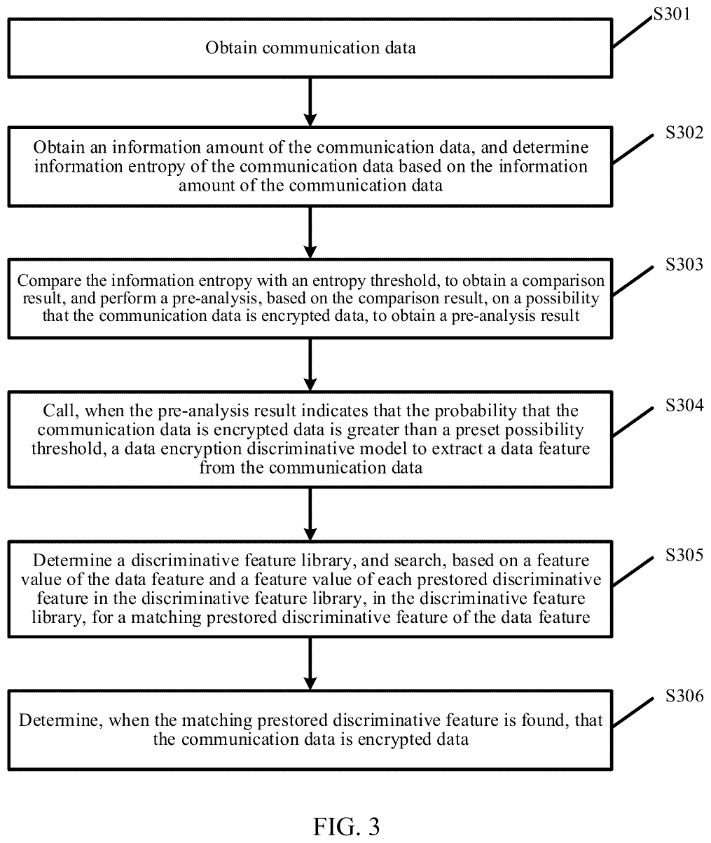

With reference to FIG. 3, a schematic flowchart of a method for performing encryption detection on communication data based on machine learning according to an embodiment of this application is shown. The method for performing encryption detection on communication data based on machine learning may be performed by a computer device (such as the computer device in the system shown in FIG. 1A). The method for performing encryption detection on communication data based on machine learning may include following S301 to S306.

S301: Obtain communication data.

In an embodiment, the operation of obtaining communication data may include following processing operations 1 and 2.

Operation 1: Obtain a communication data packet from a communication system, and extract, by a data analysis tool from the communication data packet, transmission data in the communication system.

The so-called communication system refers to a system configured to transmit communication data, such as a satellite communication system. The communication data can be transmitted in the communication system in a form of a communication data packet. The communication data packet is a data packet including the communication data, and may be obtained from the communication system by packet capture software (such as Wireshark or fiddler). In an embodiment, the obtained communication data packet may be a data packet of a medium access control layer (MAC layer), such as a generic stream encapsulation (GSE) data packet (a data packet obtained through encapsulation based on a communication stream encapsulation protocol). Real transmission data is encapsulated in the communication data packet, and is specifically encapsulated in a protocol data unit (PDU).

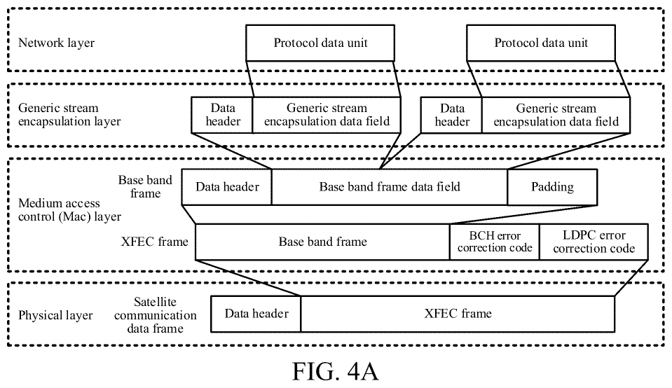

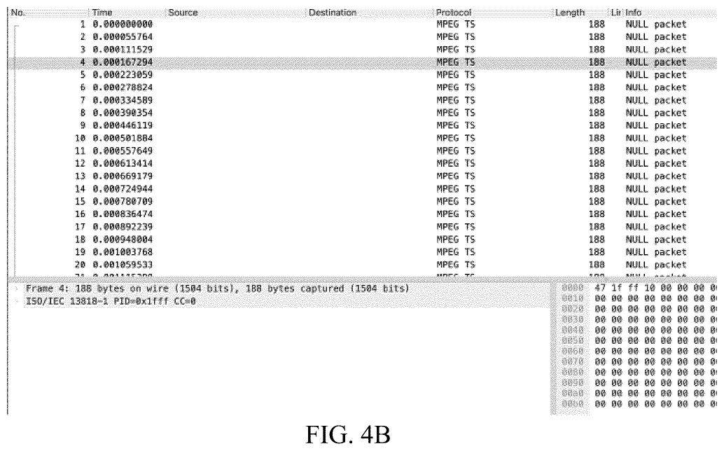

Illustratively, with satellite communication data as an example, a data encapsulation format at each layer is shown in FIG. 4A. A physical layer, a mac layer, a GSE layer, and a network layer (or referred to as an internet protocol (IP) layer) are included. The physical layer includes a satellite communication data planet frame (PL frame). The PL frame is encapsulated into a PL header and an XFEC frame. The XFEC frame is encapsulated into a base band frame (BB frame), a Bose-Chaudhuri-Hocquenghem forward error correction (BCH FEC) (a type of error correction code for forward error correction), and a low-density parity check forward error correction (LDPC FEC) (a type of error correction code for forward error correction) on the MAC layer. The base band frame includes a BB frame data field, a BB frame header, and padding. The BB frame data field is encapsulated into two GSE data packets on a GSE layer. One GSE data packet includes: a GSE header and a GSE data field. The network layer includes a PDU corresponding to the GSE layer. One PDU corresponds to one GSE data field. The protocol data unit includes transmission data.

After the communication data packet is obtained, the transmission data in the communication system may be extracted from the communication data packet by the data analysis tool. The transmission data is data required to be further analyzed. Illustratively, the transmission data may be data in various formats, such as a relatively excellent image and video, supported by a digital video broadcasting (DVB) protocol, or may be protocol data not directly supported, such as a hypertext transfer protocol (HTTP), a transmission control protocol (TCP), and a user datagram protocol (UDP). The protocol data is required to be encapsulated into an IP protocol and then is transmitted by DVB-S2. In order to improve efficiency and accuracy of a data analysis, transmission data may be stripped from the DVB protocol through a corresponding algorithm.

The data analysis tool, such as a GSE data analyzer (a tool configured to analyze a communication data packet encapsulated based on a communication stream encapsulation protocol), is configured to extract transmission data from a communication data packet. Data in the protocol data unit can be extracted by the data analysis tool. Since the transmission data is dispersed and fragmented, a communication data packet can be rapidly and efficiently parsed by the data analysis tool. Moreover, fragmented data is recombined, such that the transmission data is obtained. Thus, efficiency of extracting the transmission data can be improved, and preparation is made for next data preprocessing.

Operation 2: Perform preprocessing on the transmission data by the data analysis tool, and obtain the communication data.

Since duplicated data or padding data may exist in the extracted transmission data, and miscoding, etc. may occur during transmission to cause data anomaly, preprocessing may be performed on the transmission data by the data analysis tool. The preprocessing herein includes but is not limited to one or more types of: data deduplication, data cleaning, etc.

Through the data deduplication, duplicated data in the transmission data can be removed. Through data cleaning, an abnormal value, a missing value, etc. in the transmission data can be removed. Illustratively, the transmission data is satellite communication data. A large number of null packets exist in the satellite communication data. As shown in FIG. 4B, a null packet included in the satellite communication data can be removed through preprocessing. Thus, useless data can be prevented from being analyzed, and resources for subsequently analyzing data can be reduced.

The data analysis tool for preprocessing herein may be the same as the data analysis tool for extracting the transmission data. For example, preprocessing is performed on the transmission data by a GSE data analyzer. In this way, the transmission data is extracted and preprocessed by the same data analysis tool. That is, transmission data and preprocessed transmission data are obtained by the data analysis tool. Since the transmission data in the communication system is extracted and the preprocessing is performed on the transmission data by the same data analysis tool, processing efficiency can be improved. The transmission data after the preprocessing may be taken as communication data such that a subsequent analysis can be favorably performed on the communication data. The analysis includes but is not limited to: determination of information entropy of the communication data, extraction of a data feature of the communication data, etc.

S302: Obtain an information amount of the communication data, and determine information entropy of the communication data based on the information amount of the communication data.

Specifically, a specific implementation process of S302 may include the following operations. Obtain possibility P(xᵢ) corresponding to each reference value of the communication data. The reference value is a character or a byte, or may be a numerical value, including a possible value in a case that the communication data is encrypted data. Determine information amount log_{b}^{P(x}^{ᵢ}⁾ of a corresponding reference value of the communication data according to the possibility corresponding to each reference value of the communication data, and obtain an information amount of the communication data, which includes: an information amount of each reference value of the communication data. Determine information entropy of the communication data based on information amount log_{b}^{P(x}^{ᵢ}⁾ and corresponding possibilty P(xᵢ) of each reference value of the communication data. In an implementation, a computation formula for determining information entropy H(X) of the communication data based on information amount log_{b}^{P(x}^{ᵢ}⁾ and corresponding possibility P(xᵢ) of each reference value of the communication data is shown in formula 1) as follows:

$$H ( X ) = - {\sum }_{i = 1}^{n} P ( {x}_{i} ) {log}_{b}^{P ( {x}_{i} )} \qquad formula 1 ) .$$

Specifically, X is a random variable, and herein can represent communication data, xᵢ represents a possible value (that is, a reference value) of random variable X, and P(xᵢ) is a possibility that a value of random variable X is xᵢ. Moreover, n represents a quantity of possible values of random variable X, log_{b}^{P(x}^{ᵢ}⁾ represents an information amount of reference value xᵢ of communication data X, and b is a base number of logarithm log.

Probabilities of random variable X in cases of different values constitute possibility distribution P(X). In a case of each piece of unencrypted data, some values (such as common characters or bytes) may occur at a relatively high frequency. Thus, distribution P(X) will be uneven. Encrypted data generally has relatively excellent uniformity. Thus, distribution P(X) is closer to even distribution. When distribution P(X) is close to uniform distribution, information entropy H(X) achieves a maximum value. That is, the communication data has relatively high uncertainty and randomness. An encryption algorithm used during encryption will disrupt a structure and a rule of data, such that data will be more difficult to predict. Thus, encrypted data has relatively high information entropy.

The information entropy of the communication data is configured for indicating a level of complexity of the communication data. In an information theory, entropy can be configured for measuring information content. Entropy of information, that is, information entropy, may be configured for measuring “disorder” and “uncertainty” of an information state. Greater information entropy indicates richer information content and a greater information amount. Information entropy of the communication data is in positive correlation with the level of complexity of the communication data. The positive correlation means that greater information entropy of the communication data indicates a higher level of complexity of the communication data. Less information entropy of the communication data indicates a lower level of complexity of the communication data.

When the communication data is encrypted, information entropy of the communication data will change. Specifically, before encryption, information entropy of the communication data depends on information content of the communication data. If the information content of the communication data is complex and difficult to predict, the information entropy of the communication data will be relatively great. After the encryption, due to an encryption algorithm, the information content of the communication data will change. Thus, the information content will become more complex and difficult to predict, and the information entropy of the communication data will be increased. Thus, the information entropy of the communication data before the encryption is less than the information entropy after the encryption. Greater information entropy of the communication data indicates a higher possibility that the communication data is encrypted.

Thus, based on a feature of data encryption, the communication data is initially analyzed by selecting information entropy of the communication data. Thus, whether the communication data may be encrypted can be relatively accurately and efficiently determined. Since information entropy of encrypted communication data is greater than information entropy of unencrypted communication data, if the information entropy is greater, the communication data may be encrypted. Whether the information entropy is relatively great can be determined based on a comparison with an entropy threshold.

S303: Compare the information entropy with an entropy threshold to obtain a comparison result, perform a pre-analysis, based on the comparison result, on a possibility that the communication data is encrypted data, and obtain a pre-analysis result.

Information entropy corresponding to any piece of communication data after the encryption is greater than information entropy corresponding to any piece of communication data before the encryption. For example, in a case of data A (that is, communication data before the encryption), communication data that can be obtained after encryption is data A′. Information entropy of the data A′ is greater than information entropy of the data A. The entropy threshold for a comparison may be set according to an empirical value, and may be specifically set as a threshold that can ensure that whether the communication data is encrypted can be relatively accurately determined. In a case of the entropy threshold, missing determination of encrypted data or mistaken determination of unencrypted data can be reduced as much as possible.

A corresponding comparison result can be obtained based on a comparison between the information entropy and the entropy threshold. In a case that a pre-analysis is performed, based on different comparison results, on the possibility that the communication data is encrypted data, obtained pre-analysis results are different, which specifically include the following content. (1) If the comparison result indicates that the information entropy of the communication data is greater than or equal to the entropy threshold, the pre-analysis result indicates that the possibility that the communication data is encrypted data is greater than the preset possibility threshold. (2) If the comparison result indicates that the information entropy of the communication data is less than the entropy threshold, the pre-analysis result indicates that a possibility that the communication data is unencrypted data is greater than the preset possibility threshold.

Specifically, if the information entropy is greater than or equal to the entropy threshold, the level of complexity of the communication data is relatively high, and the possibility that the communication data is encrypted is relatively high. Thus, the pre-analysis result can indicate that the possibility that the communication data is encrypted data is greater than the preset possibility threshold. If the information entropy is less than the entropy threshold, the level of complexity of the communication data is relatively low, and the possibility that the communication data is encrypted is relatively low. Thus, the pre-analysis result can indicate that the possibility that the communication data is unencrypted data is greater than the preset possibility threshold. In the method, the possibility that the communication data is encrypted data is indicated by the information entropy. The possibility threshold may be an entropy threshold.

Thus, information entropy of the communication data is obtained, and a pre-analysis result is generated based on a comparison result between the information entropy of the communication data and an entropy threshold. Thus, an initial discrimination of encrypted data can be performed on the communication data. Further, the level of the encryption possibility (that is, a possibility that the communication data is encrypted data) of the communication data can be determined.

When the information entropy is greater than or equal to the entropy threshold, the pre-analysis result indicates that an encryption possibility of the communication data is relatively high. In this case, the data encryption discriminative model may be called for a further analysis. Thus, whether the communication data is encrypted data can be more accurately determined. When an encryption possibility is relatively high, machine learning is combined. Thus, problems in the following aspects can be mainly resolved. On the one hand, during discrimination based on information entropy, even if the communication data is not encrypted, since the data has randomness, information entropy corresponding to the data will be relatively large. Unencrypted data may be determined to be encrypted data. On the other hand, information entropy of encrypted data may be different due to different encryption methods. Based on the information entropy, encrypted data may be mistakenly determined to be unencrypted data. Not all encrypted data can be accurately determined. However, the data encryption discriminative model in an embodiment of this application can learn features of encrypted data in different encryption methods through training, can be suitable for any piece of communication data, and has relatively high compatibility of encryption detection on encrypted data corresponding to various encryption methods. Thus, compared with the method of directly determining whether data is encrypted data according to information entropy, the solution has the benefit that based on a combination of the information entropy and the encryption discriminative model obtained through machine learning, accuracy of determining encrypted data can be further improved. Further, effectiveness of detecting encrypted data can be improved.

S304: Call, when the pre-analysis result indicates that the possibility that the communication data is encrypted data is greater than a preset possibility threshold, a data encryption discriminative model to extract a data feature from the communication data.

In an embodiment, a flow of obtaining a data encryption discriminative model by performing training based on machine learning may include flowing S1 to S3.

S1: Obtain a training sample set. The training sample set includes at least one piece of encrypted communication sample data and at least one piece of unencrypted communication sample data.

One piece of encrypted communication sample data in the training sample set corresponds to one piece of unencrypted communication sample data. Any piece of encrypted communication sample data is obtained by encrypting corresponding unencrypted communication sample data. For example, after unencrypted communication sample data Q is encrypted, encrypted communication sample data Q′ can be obtained. Moreover, the unencrypted communication sample data Q and the encrypted communication sample data Q′ may all be taken as communication sample data in the training sample set.

In an implementation, unencrypted communication sample data in the training sample set may roughly include real communication data collected during real communication and analogue communication data obtained through analogue communication. According to different data sources, data specifically include one or more types of: analogue communication data, real communication data, standard communication data, and merged communication data. The analogue communication data is obtained by calling an analogue communication system for communication simulation. The real communication data is obtained by calling a real communication system for real communication. The standard communication data is data that is randomly generated and satisfies a communication standard. The merged communication data is obtained by merging at least two pieces of existing unencrypted communication sample data.

Illustratively, the unencrypted communication sample data may be unencrypted satellite communication data. Each piece of unencrypted communication sample data may include: analogue communication data generated by an analogue satellite communication system (such as a computer software or hardware analogue satellite communication system); real satellite communication data collected after real communication is performed by a real satellite communication system (such as a real satellite communication system used inside or outside a laboratory); communication data that satisfies a satellite communication standard and is simulated by a data generator (such as a computer program for generating a large amount of random data); and data extracted from an existing database or a large amount of data generated by merging a plurality of databases. Encrypted communication sample data can be obtained based on separately encrypting one or more types of analogue communication data, real communication data, standard communication data, and merged communication data.

In order to cause the data encryption discriminative model to accurately determine encrypted data in various encryption methods, in a case of construction of the training sample set, massive unencrypted communication sample data may be first obtained. Then, each piece of the unencrypted communication sample data is encrypted through different encryption methods and by using different encryption strength, such that encrypted communication sample data is obtained. Each piece of the encrypted communication sample data and each piece of the unencrypted communication sample data are added to the training sample set.

If the same unencrypted communication sample data is encrypted through different encryption methods, obtained encrypted communication sample data is different. For example, unencrypted communication sample data Q is encrypted through symmetric encryption and asymmetric encryption, such that encrypted communication sample data Q1′ and encrypted communication sample data Q2′ are obtained. Based on different encryption methods, Q1′ and Q2′ are different. In a case that the unencrypted communication sample data is encrypted, an encryption method used may include one or more types of: symmetric encryption (such as an advanced encryption standard (AES) or data encryption standard (DES)), asymmetric encryption (such as Reivest-Shamir-Adleman (RSA)), hash encryption (such as secure Hash algorithm 256-bit (SHA-256)), a digital signature, hybrid encryption, etc. When encryption is performed through the above encryption method, encryption strength may be further set. Thus, richer and diversified encrypted communication sample data can be obtained.

Model training is performed based on various types of communication sample data (including encrypted communication sample data and unencrypted communication sample data) included in the training sample set. A model training effect can be improved due to diversity of the communication sample data. A data encryption discriminative model having better generalization can be obtained. Moreover, accuracy of determining whether the communication data is encrypted by the data encryption discriminative model can be improved.

S2: Extract a sample feature from each piece of encrypted communication sample data, and extract a sample feature from each piece of unencrypted communication sample data. A sample feature from encrypted communication sample data is also referred to as an “encrypted-data sample feature,” and a sample feature from unencrypted communication sample data is also referred to as an “unencrypted-data sample feature.”

Feature extraction is required to be performed on each piece of communication sample data in the training sample set, such that a sample feature of each piece of communication sample data is obtained. That is, a sample feature of each piece of encrypted communication sample data and a sample feature of each piece of unencrypted communication sample data are obtained. There is a corresponding difference between a sample feature of the encrypted communication sample data and a sample feature of the unencrypted communication sample data. A sample feature of any piece of encrypted communication sample data may be configured for reflecting an encryption method of the encrypted communication sample data. A sample feature of any unencrypted communication sample data may be configured for reflecting original information of the unencrypted communication sample data. The communication sample data before and after encryption can be distinguished from each other based on sample features. Illustratively, sample features are values of some statistics (such as an average, a variance, and a correlation coefficient). Values of statistics of the same the communication sample data before and after encryption will clearly change.

In an embodiment, logic of performing feature extraction on any piece of communication sample data (including encrypted communication sample data or unencrypted communication sample data) in the training sample set may be shown in following (1) to (3).
(1) A feature analysis is performed on each piece of encrypted communication sample data. An initial feature of each piece of encrypted communication sample data is obtained. A feature analysis is performed on each piece of unencrypted communication sample data. An initial feature of each piece of unencrypted communication sample data is obtained. The initial feature of encrypted communication sample data is also referred to as an “encrypted-data initial feature,” and an initial feature of unencrypted communication sample data is also referred to as an “unencrypted-data initial feature.”

In a feature analysis process, a feature of the communication sample data can be extracted by analyzing some statistics (such as an average, a variance, and a correlation coefficient) of the communication sample data or through some feature extraction methods (such as Fourier transformation and wavelet transformation). The communication sample data may be analyzed in different dimensions, such that an initial feature of the communication sample data is obtained. The initial feature may be configured for expressing information about the communication sample data in plurality of dimensions. Unnecessary information may exist in the initial feature, resulting in information redundancy. For example, the initial feature may include some unnecessary feature values to express data. Thus, whether a piece of communication sample data is encrypted cannot be well expressed based on the initial feature. Thus, a feature that can accurately indicate whether data is encrypted is required to be further extracted from the initial feature.
(2) A target feature is extracted from an initial feature of any piece of communication sample data according to a feature difference between an initial feature of the encrypted communication sample data and an initial feature of corresponding unencrypted communication sample data. The target feature is configured for distinguishing the encrypted communication sample data from the corresponding unencrypted communication sample data.

If data is encrypted, an original structure or included information of the data may be changed. For example, some identification information or a file header is added through encryption. As a result, expressions of a feature before and after encryption will be affected. Thus, the target feature can be extracted from the initial feature according to a feature difference between a corresponding initial feature of the communication sample data before and after encryption. The feature difference may be configured for reflecting a change situation of the initial feature before and after encryption. Whether the feature difference is clear can be determined based on the feature difference and a difference threshold. A corresponding feature, which has a relatively clear feature difference, of the communication sample data before and after encryption is taken as a target feature. Encrypted communication sample data and corresponding unencrypted communication sample data can be distinguished from each other based on the target feature. Specifically, a target feature of the encrypted communication sample data may be extracted from the initial feature of the encrypted communication sample data, or a target feature of the unencrypted communication sample data may be extracted from the initial feature of the unencrypted communication sample data. Through the above feature analysis, which features can be most configured for distinguishing data before and after encryption can be determined.

In an implementation, the target feature may be directly taken as a sample feature of any piece of communication sample data, to be configured for model training. In another implementation, for ease of processing and analysis, a target feature may be taken as a sample feature after further processed, as shown in (3).
(3) Perform dimension reduction on the target feature, and obtain a sample feature of any piece of communication sample data.

A data dimension of the target feature after the dimension reduction is less than a data dimension of the target feature. Through dimension reduction, high-dimensional data can be projected into a low-dimensional space, and data variances are reserved as many as possible. Thus, redundant information in the target feature can be further reduced. Subsequent further processing (such as clustering) based on a feature can be facilitated. The dimension reduction mentioned above includes but is not limited to: a principal component analysis, an independent component analysis, etc. If the target feature is extracted from the initial feature of the encrypted communication sample data, the target feature after the dimension reduction is a sample feature of the encrypted communication sample data. If the target feature is extracted from the initial feature of the unencrypted communication sample data, the target feature after the dimension reduction is a sample feature of the unencrypted communication sample data.

Through feature extraction, feature changes of the communication sample data before and after encryption can be mined. Thus, a feature that effectively distinguishes between changes of the communication sample data before the encryption and the communication sample data after the encryption can be extracted. Subsequently, the trained data encryption discriminative model is used for prediction of data encryption such that a data feature of the communication data can be accurately extracted. Further, whether the communication data is encrypted is determined such that encryption of the communication data can be effectively detected.

S3: Train an initial discriminative model according to the sample feature of each piece of encrypted communication sample data and the sample feature of each piece of unencrypted communication sample data, obtain a trained discriminative model, and take the trained discriminative model as the data encryption discriminative model.

In a practicable embodiment, the data encryption discriminative model may be trained based on a supervised method or an unsupervised method. A main difference between these two learning methods lies in whether a label exists.

In a supervised method, any piece of communication sample data in the training sample set carries a label. If the communication sample data is encrypted communication sample data, the label can be configured for indicating that the encrypted communication sample data is encrypted data. If the communication sample data is unencrypted communication sample data, the label can be configured for indicating that the unencrypted communication sample data is unencrypted data. Moreover, S3 specifically includes: generate, according to a sample feature of each piece of communication sample data, a predicted label of corresponding communication sample data, and train the initial discriminative model by using a predicted label of each piece of communication sample data and a label of the corresponding communication sample data.

Specifically, any piece of communication sample data may be predicted based on a sample feature of the any piece of communication sample data, such that a predicted label of any piece of communication sample data is obtained. The predicted label may be configured for indicating whether the any piece of communication sample data is encrypted data. The communication sample data herein may be encrypted communication sample data or unencrypted communication sample data. Since in an early training stage, learning, by the initial discriminative model, of information included in the communication sample data before and after encryption is limited, the generated predicted label may be inaccurate. For example, a predicted label of encrypted communication sample data may indicate that the encrypted communication sample data is unencrypted data. A predicted label of unencrypted communication sample data may indicate that the unencrypted communication sample data is encrypted data. A label carried in corresponding communication sample data may be taken as one piece of supervision data such that a learning effect of the model can be optimized. The label plays a supervision role as follows: Firstly, a classification loss may be constructed based on a difference between the label and the predicted label. Then, a parameter of an initial discriminative model is updated in a direction of reducing the classification loss until model convergence is achieved. The model convergence herein includes but is not limited to: a case that a loss of the discriminative model in a training process achieves a minimum value; a case that a loss of the discriminative model is stable in a training process, and as a quantity of times of training increases, the loss no longer changes or a change amplitude is less than a preset threshold; a case that training duration of the discriminative model achieves preset training duration; a case that a quantity of times of iterative training of the discriminative model achieves a preset quantity of times of training; and so on.

Training on the discriminative model is a continuous iteration process. Before the model convergence is reached, feature extraction and label prediction may be repeated. After model parameters are continuously updated, the model has a relatively excellent feature extraction capacity and category prediction. A trained discriminative model may be finally obtained, and is taken as a data encryption discriminative model for classifying encrypted data and unencrypted data. Common supervised learning algorithms include linear regression, logistic regression, a decision tree, a random forest, a support vector machine, a neural network, etc. The data encryption discriminative model may be trained through any supervised learning algorithm mentioned above.

A training sample set in a case of a supervised learning algorithm includes known input (which is encrypted communication sample data herein) and corresponding output (or a target variable, which is a label herein). An objective of the algorithm is to learn a mapping relationship between input and output, so as to predict output corresponding to new future input. In supervised learning, an algorithm is required to learn how to predict output by using input, and can adjust a model parameter according to a difference with real output, so as to improve prediction accuracy.

In an unsupervised method, any piece of communication sample data in the training sample set has no label. That is, encrypted communication sample data and unencrypted communication sample data all carry no label. Moreover, S3 specifically includes: perform, according to a sample feature of each piece of communication sample data, classification prediction on corresponding communication sample data, and train the initial discriminative model by using a classification prediction result.

In an implementation, the sample feature of each piece of communication sample data may include: a sample feature of each piece of encrypted communication sample data in the training sample set, and a sample feature of each piece of unencrypted communication sample data in the training sample set. The unsupervised learning algorithm may include clustering, dimension reduction, anomaly detection, etc. Any algorithm may be applied to training on the data encryption discriminative model. A clustering analysis is taken as an example herein for exemplary descriptions.

The clustering analysis may be performed on each piece of communication sample data in the training sample set according to each sample feature. The communication sample data may be classified into different categories through the clustering analysis. Similar data points are clustered together to form a category. Dissimilar data points are classified into different categories. A clustering result obtained through the clustering analysis may include different categories of communication sample data. The categories herein may be encrypted data and unencrypted data. Further, in a case of encrypted data, clustering may be performed according to different encryption methods and/or encryption strength. Encrypted communication sample data obtained by using the same encryption method and/or encryption strength is clustered into one category. Encrypted communication data obtained by using different encryption methods and/or encryption strength belongs to different categories.

Through the clustering analysis, clustering situations of the encrypted communication sample data and the unencrypted communication sample data can be found. Then, whether clustering situations of the communication sample data before and after encryption are different is analyzed. A change of a feature of the communication sample data after the encryption relative to a feature before the encryption is further determined. Thus, whether a sample feature of the communication sample data is required to be further optimized subsequently can be determined.

In unsupervised learning, the training sample set includes only input and has no corresponding output. An objective in the learning method is to discover a pattern and a structure from encrypted communication sample data, so as to better understand data and perform a data analysis. In unsupervised learning, an algorithm is required to learn how to automatically discover a structure and a mode in encrypted communication sample data, without manual intervention or label provision.

The above data encryption discriminative model may include a classifying model built by using a neural network. The neural network is, for example, one type of or combinations of a plurality of types of a convolutional neural network, a residual network, and a recurrent neural network. This is not limited in this application. Based on the neural network, a complex nonlinear relationship of data may be learned, and classification prediction may be performed on new data. Specifically, each piece of communication data may be classified into two categories, that is, data before and after encryption. In a training process of a neural network, an obtained data set may be divided into a training sample set and a testing sample set. Firstly, a neural network model is trained by using the training sample set. Then, performance of the model is evaluated by using the testing sample set. If a prediction accuracy rate of the model is extremely high, the model can accurately classify data into two categories, that is, data before and after encryption. Thus, whether a data source is encrypted can be detected.

In conclusion, based on the training flow of the data encryption discriminative model introduced in S1 to S3, a category of unencrypted communication sample data, and an encryption method that may be used, a huge amount of unencrypted communication sample data in different types and different services may be encrypted through data encryption technologies in different forms, such that encrypted communication sample data is obtained. The encrypted communication sample data and the unencrypted communication sample data are processed by combining various machine learning methods. Further, a sample feature that can express whether data is encrypted is fully mined. Model training is performed based on the sample feature of each piece of communication sample data. A data encryption discriminative model having a capacity to classify communication data can be obtained. Thus, a feature extraction capacity of the data encryption discriminative model can be improved. The data encryption discriminative model may be pre-trained and directly called in a corresponding scenario, so as to finally determine whether the communication data is encrypted data or unencrypted data. Thus, efficiency of encryption detection on the communication data can be improved.

In a practicable embodiment, the discriminative feature library may be associated with the data encryption discriminative model. The discriminative feature library is obtained by performing feature extraction on encrypted communication sample data. The above encrypted communication sample data is communication sample data used in a model training process. The encrypted communication sample data is obtained by encrypting corresponding unencrypted communication sample data through different encryption methods. The unencrypted communication sample data includes: one or more types of analogue communication data, real communication data, standard communication data, and merged communication data.

Specifically, after the data encryption discriminative model is trained, the data encryption discriminative model may be called to perform feature extraction on all pieces of encrypted communication sample data. Thus, an encryption feature of each piece of encrypted communication sample data is obtained. The encryption feature, compared with a sample feature in a training process, can more accurately indicate an encryption method and/or encryption strength of the encrypted communication sample data. Further, these encryption features may be taken as prestored discriminative features to be added to the discriminative feature library, and are configured for performing subsequent hit detection based on a feature value. When the discriminative feature library is constructed, based on encrypted communication sample data obtained by encrypting massive unencrypted communication sample data in different types and different services through different encryption methods, the constructed discriminative feature library may cover prestored discriminative features corresponding to more diversified encrypted data. Further, at a feature search stage, whether the communication data is encrypted data can be ensured to be accurately determined as much as possible through a feature value comparison. Detection can be effectively performed on the communication data.

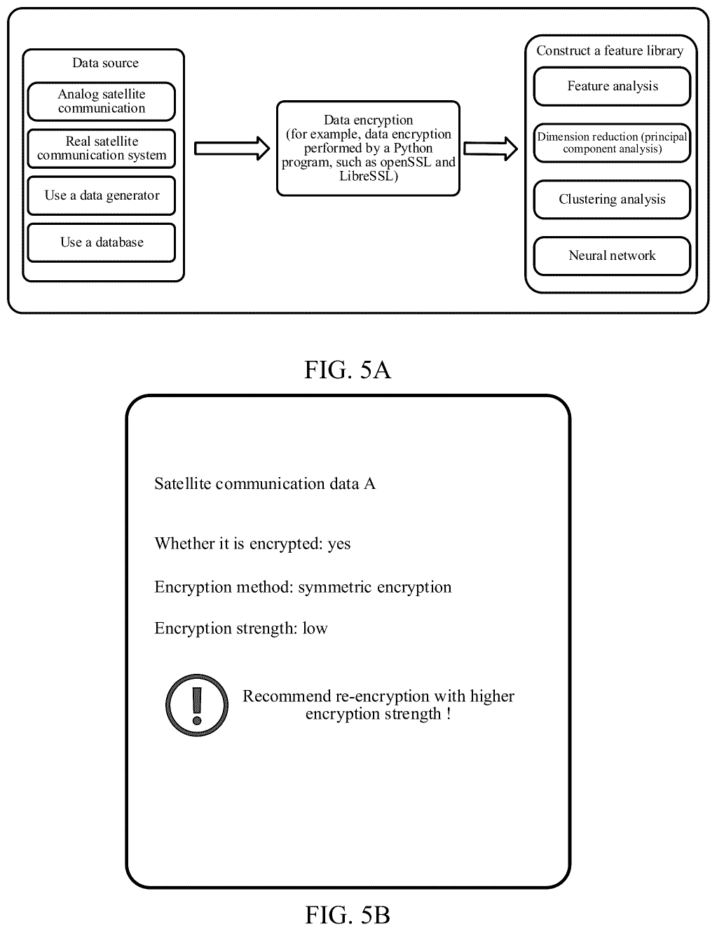

Construction of the discriminative feature library can be obtained with reference to FIG. 5A as below. The prestored discriminative features in the discriminative feature library may be obtained by comprehensively using a plurality of types of machine learning methods. The machine learning methods include but are not limited to: a feature analysis (removal of an irrelevant feature), dimension reduction (a principal component analysis and an independent component analysis), a clustering (K-means, hierarchical clustering, etc.) analysis, a neural network (a multilayer perceptron and a convolutional neural network), etc. Through the above machine learning, feature extraction can be performed on the encrypted communication sample data. An extracted encryption feature is added to the discriminative feature library as a prestored discriminative feature.

Illustratively, after a set of communication data is encrypted by a python program (a python program for encryption, such as OpenSSL and LibreSSL), the set of communication data includes plenty of features and labels. The feature is, for example, a file header or identifiable information added in an encryption process. The label may be configured for indicating that data is encrypted. When the discriminative feature library is constructed, a feature analysis may be first performed on the encrypted communication data through a feature analysis method. For example, a feature of the data is extracted through a statistical analysis, Fourier transformation, wavelet transformation, etc. Thus, which features can be configured for distinguishing between data before and after encryption can be determined. For example, through an analysis, values of some statistics clearly change before and after encryption. This may be an impact caused by encryption. Thus, values of statistics that clearly change may be taken as features. Then, dimension reduction can be performed on a feature obtained through a feature analysis from a high-dimensional space to a low-dimensional space through a principal component analysis. Data variances can be reserved as much as possible. In this way, a data set (including features obtained after the dimension reduction) having a relatively low dimension can be obtained. Thus, a subsequent clustering analysis can be facilitated. Then, features in the data set are classified into different categories through a clustering analysis. Thus, a change of a feature before and after encryption can be further determined. In conclusion, a feature analysis, dimension reduction, and a clustering analysis may assist determination of different features of data before and after encryption. An encryption feature of encrypted communication sample data may be added to the discriminative feature library.

In an implementation, the above feature analysis, dimension reduction, and clustering processing may be logic of the data encryption discriminative model obtained through training based on a neural network. The data encryption discriminative model may classify all communication data into two categories, that is, data before and after encryption, such that binary classification of input data is implemented. In a particular implementation, the binary classification may be implemented through a comparison to a feature in the discriminative feature library.

S305: Determine a discriminative feature library, and search, based on a feature value of the data feature and a feature value of each prestored discriminative feature, in the discriminative feature library, for a matching prestored discriminative feature of the data feature.

In a practicable implementation, a similarity between the data feature and each prestored discriminative feature may be first computed according to the feature value of the data feature and the feature value of each prestored discriminative feature. Then, it is determined that the matching prestored discriminative feature of the data feature is searched for in the discriminative feature library according to the similarity between the data feature and each prestored discriminative feature.

Specifically, the data feature and the prestored discriminative feature may both vector representations in a vector space. The feature value is a numerical value of a vector representation. A similarity between the data feature and each prestored discriminative feature in the vector space is computed based on a feature value, which includes but is not limited to any one type of: a Euclidean distance, a Manhatton distance, cosine similarity, etc. This is not limited in this application. The computed similarity may correspond to a corresponding prestored discriminative feature. For example, if the discriminative feature library includes 100 prestored discriminative features, then corresponding 100 similarities between the data feature and the 100 prestored discriminative features may be computed. Different similarities may be configured for reflecting degrees of matching between the data feature and feature values of different prestored discriminative features. A greater similarity indicates a higher degree of matching.

According to a similarity between the data feature and each prestored discriminative feature, a matching prestored discriminative feature of the data feature is searched for in the discriminative feature library, which may include either of following methods (1) and (2). (1) Compare each similarity with a similarity threshold, and determine, if a prestored discriminative feature having a similarity greater than the similarity threshold exists, that the matching prestored discriminative feature of the data feature is found. Otherwise, determine that no matching prestored discriminative feature of the data feature is found. (2) Determine a maximum similarity from similarities between the data feature and the prestored discriminative features, and determine, if the maximum similarity is greater than the preset threshold, that the matching prestored discriminative feature of the data feature is found. Otherwise, determine that no matching prestored discriminative feature of the data feature is found.

Illustratively, if the discriminative feature library includes 100 prestored discriminative features, corresponding 100 similarities with the data feature may be computed. Then, a similarity having a maximum numerical value may be determined from the 100 similarities. The similarity is compared with the preset threshold. When the similarity is greater than the preset threshold, it is determined that the matching prestored discriminative feature of the data feature is found.

S306: Determine, when the matching prestored discriminative feature is found, that the communication data is encrypted data.

In an implementable method, when no matching prestored discriminative feature of the data feature is found, or information entropy is less than or equal to an entropy threshold, the communication data can be determined to be unencrypted data. In an embodiment, after the communication data is determined to be encrypted data or unencrypted data, a discrimination result of the communication data may be visually presented. An operation of visually presenting a discrimination result of the communication data specifically includes: generate, when the communication data is determined to be encrypted data, a first discrimination result of the communication data; generate, when the communication data is determined to be unencrypted data, a second discrimination result of the communication data; and display an application interface, and display the first discrimination result or the second discrimination result on the application interface according to a target format.

The first discrimination result is a result that the communication data is determined to be encrypted data. The second discrimination result is a result that the communication data is determined to be unencrypted data. Any discrimination result is generated when the communication data is determined to be encrypted data or unencrypted data. Encryption discrimination on the communication data includes data feature extraction based on the data encryption discriminative model, and feature search based on the feature value of the data feature and the feature value of the prestored discriminative feature, or may include only the pre-analysis, based on the information entropy of the communication data, on the possibility that the communication data is encrypted data, such as initial encryption discrimination based on the information entropy. The application interface is an interface for presenting the discrimination result. The first discrimination result or the second discrimination result may be displayed on the application interface. Specifically, the first discrimination result may be displayed on the application interface after the communication data is determined to be encrypted data. The second discrimination result may be displayed on the application interface after the communication data is determined to be unencrypted data. The target format may be configured for indicating an output form of the discrimination result (including the first discrimination result and the second discrimination result). The target format may include one or more types of: an image, a text, a form, audio, and video.

In an embodiment, in addition to outputting the discrimination result on the application interface, other content may be further outputted based on different discrimination results. (1) If the first discrimination result is displayed on the application interface according to the target format, one or two of a current encryption method and the current encryption strength of the communication data is displayed on the application interface. (2) If the second discrimination result is displayed on the application interface according to the target format, one or two of a recommended encryption method and recommended encryption strength that match the security of the communication data is displayed on the application interface.

A current encryption method is an encryption method currently used for the communication data. Current encryption strength is encryption strength currently used for the communication data. The current encryption method and the current encryption strength are obtained based on a data feature analysis on the communication data. A recommended encryption method is an encryption method recommended for the communication data. Recommended encryption strength is encryption strength recommended for the communication data. Moreover, the encryption method and the encryption strength may be displayed in a target format, such as video, an image, and a text. Illustratively, reference can be made to a schematic diagram of outputting a discrimination result shown in FIG. 5B. Information related to satellite communication data A is outputted on the application interface, including a discrimination result indicating that the satellite communication data is encrypted data, and further including content that an encryption method of the encrypted data is symmetric encryption, encryption strength is relatively low, etc.

If the communication data is encrypted data, a used encryption method and/or encryption strength may be further displayed on the application interface. If the communication data is unencrypted data, an encryption method and/or encryption strength recommended for the communication data may be further displayed on the application interface. If the above content is outputted in a case that the data is unencrypted, a recommendation solution for encrypting unencrypted data may be provided. By performing encryption through the recommendation solution, security of transmitting the communication data after encryption can be ensured.

By presenting the discrimination result of the data encryption discriminative model in a form of a chart, a text, a table, etc., the discrimination result can be intuitively presented to an object. The object can rapidly learn a detection result, evaluates a hidden hazard existing during data transmission, and provides an effective solution to ensure data security.

In an embodiment, security may be reinforced based on discrimination of the communication data. An operation of reinforcing security specifically includes: obtain, when the communication data is determined to be encrypted data, current encryption strength of the communication data; compare the current encryption strength with a preset strength threshold, and obtain a comparison result; and recommend, if the comparison result indicates that the current encryption strength is less than the preset strength threshold, encryption strength matching security of the communication data. The encryption strength matching the security of the communication data is greater than the current encryption strength.

Specifically, when the communication data is encrypted data, an encryption strength analysis may be further performed on the communication data. Thus, encryption strength (that is, current encryption strength) used by the communication data in an encryption process can be determined. When the encryption strength is less than a preset strength threshold, the current encryption strength used by the communication data cannot sufficiently ensure transmission security of the communication data. Thus, encryption strength greater than the current encryption strength can be recommended for encryption, so as to match security required for the communication data.

When the communication data is determined to be encrypted data, reference may be provided for transmission security of the communication data based on an analysis on encrypted data, so as to assist construction of a more perfect information security protection solution. According to the solution, powerful tools for a data security research and a network security analysis can be provided.

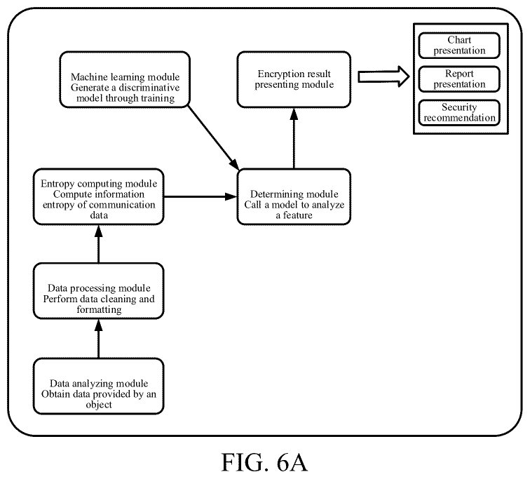

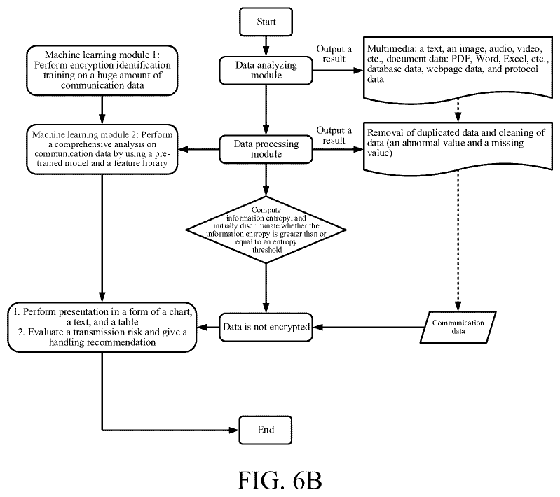

In conclusion, a framework diagram of processing communication data based on machine learning shown in FIG. 6A may be provided. As shown in FIG. 6A, the following models are mainly included: an entropy detection tool module and an encryption detection machine learning module.

The entropy detection tool module includes submodules as follows: (1) a data analyzing module configured to extract the transmission data from the communication data packet; (2) a data processing module configured to perform preprocessing, such as deduplication and cleaning, on the transmission data extracted by the data analyzing module; (3) an entropy computing module configured to compute information entropy of the communication data according to a definition formula of entropy; (4) a determining module configured to call a data encryption discriminative model generated by a machine learning module to perform a comprehensive analysis on to-be-processed communication data, determine whether the communication data is encrypted, analyze a feature of encrypted data, etc.; and (5) an encryption result presenting module configured to display a result of analyzing information entropy of the communication data and a data feature (if the communication data is encrypted data, the data feature is correspondingly an encryption feature) of the communication data in a form of a chart, a report, etc., and provide a security recommendation.

The encryption detection machine learning module (or briefly referred to as a machine learning module) is configured to analyze the communication sample data according to a machine learning algorithm, for example, perform feature mining on the encrypted communication sample data, classify encrypted data and unencrypted data, and generate, through training, a data encryption discriminative model for the determining module to use.

Based on introductions of specific functions of the above functional modules, a process of data transfer involved between the functional modules will be described as follows: Firstly, a communication data packet may be obtained and analyzed by the data analyzing module. Transmission data is extracted from the communication data packet. The communication data packet may be a data packet provided by an object and transmitted in a corresponding communication system, such as a satellite communication data packet. By analyzing the satellite communication data packet, to-be-analyzed data can be extracted from the satellite communication system. Thus, a data source can be initially processed. The data analyzing module may transmit the extracted transmission data to the data processing module. Then, the data processing module may perform preprocessing, such as data cleaning, formatting, and data deduplication, on the transmission data. Thus, communication data is obtained. The data processing module may transmit the communication data to the entropy computing module. Next, information entropy of the communication data may be computed by the entropy computing module. The information entropy is compared with an entropy threshold. When the information entropy is greater than the entropy threshold, the data encryption discriminative model may be obtained by the determining module from the machine learning module. The data encryption discriminative model is called to perform data feature extraction on the communication data, such that a data feature of the communication data is obtained. Whether the communication data is encrypted data is determined according to the data feature of the communication data and a prestored discriminative feature in the discriminative feature library, such that an encryption detection result (or referred to as a discrimination result) is obtained. The determining module may transmit the encryption detection result to the encryption result presenting module. Finally, the encryption detection result may be presented by the encryption result presenting module. In some embodiments, a presentation method includes but is not limited to: one type of or combinations of a plurality of types of an image, a text, video, and audio. For example, the encryption detection result is presented in a form of a chart or a report. In addition, the encryption result presenting module may further present a provided security recommendation.

The data encryption discriminative model may be pre-trained and stored in the machine learning module. A process of generating the data encryption discriminative model by the machine learning module specifically includes: obtain and take encrypted communication sample data and unencrypted communication sample data as a training sample set, perform feature extraction on each piece of communication sample data in the training sample set, obtain a sample feature of each piece of communication sample data, train an initial discriminative model by using the sample feature of each piece of communication sample data, and obtain the data encryption discriminative model. The determining module and the machine learning module may be in communication with each other. When the determining module is required to call the data encryption discriminative model, the determining module may transmit a request to the machine learning module to call the data encryption discriminative model.

Further, based on the above framework diagram, a schematic flowchart of processing communication data based on machine learning shown in FIG. 6B may be provided. In the flowchart, modules in the framework diagram shown in FIG. 6A are combined for processing. In an overall flow, to-be-processed communication data, such as a multimedia file (audio, video, a picture, etc.), a piece of document data (PDF, Word, Excel, etc.), a database file, a webpage file, and a piece of protocol data, of which communication standards are DVB-S/S2/S2X, may be obtained first. Then, an encryption detection result of the communication data may be finally obtained after processing. Whether the communication data is encrypted, and a corresponding data security protection and security recommendation are provided. Thus, a hidden safety hazard in the communication data can be avoided.

Specifically, a processing flow in combination with various modules is as follows: (1) Analyze a communication data packet by a data analyzing module, and extract transmission data included in the communication data packet. The transmission data includes but is not limited to: multimedia data (such as a text, an image, audio, and video), document data (such as PDF, Word, and Excel), database data, webpage data, and protocol data (such as TCP and UDP). (2) Perform, by the data processing module, data deduplication (that is, removal of duplicated data) and data cleaning (removal of an abnormal value, removal of a missing value, etc.) on an output result of the data analyzing module, and the communication data. (3) Compute information entropy by an entropy computing module, and perform, according to whether the information entropy is greater than an entropy threshold, a pre-analysis on a possibility that the communication data is encrypted data. Perform corresponding processing according to different pre-analysis results. (4) Perform, if the information entropy is greater than or equal to the entropy threshold, a comprehensive analysis on the communication data by using a data encryption discriminative model obtained through pre-training and a discriminative feature library, call an encryption result presenting module, and display, in a form of a chart, a text, a table, video, audio, etc., a discrimination result (which may indicate whether the communication data is encrypted data) of the data encryption discriminative model on the communication data. Evaluate a transmission risk based on the discrimination result, and provide a handling recommendation. (5) Directly determine, if the information entropy is less than the entropy threshold, that the communication data is not encrypted, call the encryption result presenting module, and present a corresponding result according to a presentation form the same as that of the above discrimination result.

When the solution provided in this application is applied to various communications systems (such as a satellite communication system), based on efficient and accurate detection for the communication data, a hidden safety hazard existing in the communication data can be found in time. Thus, assistance is offered to security evaluation on a security risk of the data transmission. Reference is provided for improving a security solution of a communications transmission system.

According to the method for performing encryption detection on communication data based on machine learning provided in embodiments of this application, machine learning may be used in cooperation with information entropy detection. A possibility that communication data is encrypted data is determined by comparing information entropy with an entropy threshold. When the possibility that the communication data is encrypted data is relatively high, feature extraction is performed on the communication data by the data encryption discriminative model obtained through machine learning training. Based on encrypting massive communication data in different types and different services in a training process, a feature of the encrypted communication data is mined through a machine learning technology. Thus, a data feature of the communication data can be accurately extracted. Further, based on the data feature, whether the communication data is encrypted can be rapidly and effectively determined, and whether the communication data is encrypted can be efficiently detected. Moreover, a false determination rate of the communication data can be reduced, and an accuracy rate of determining whether the communication data is encrypted can be effectively improved. Thus, effectiveness of encryption detection on data can be improved.

The apparatus for performing encryption detection on communication data based on machine learning involved in an embodiment of this application will be stated next.

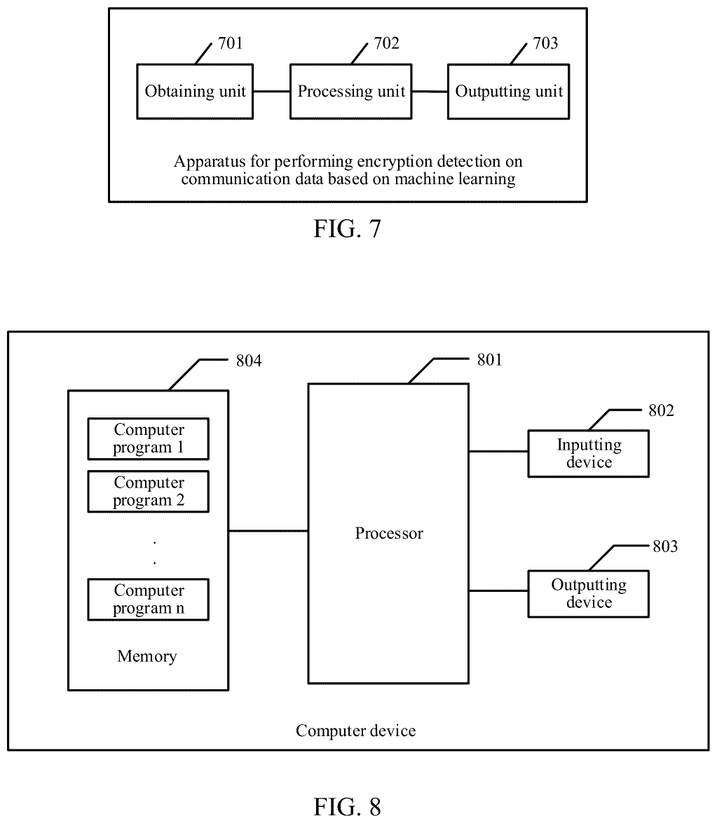

With reference to FIG. 7, a schematic structural diagram of an apparatus for performing encryption detection on communication data based on machine learning according to an embodiment of this application is shown in FIG. 7. The apparatus for performing encryption detection on communication data based on machine learning may be arranged in a computer device provided in an embodiment of this application. The computer device may be the terminal device mentioned in the above method embodiment. The apparatus for performing encryption detection on communication data based on machine learning shown in FIG. 7 may be a computer program (including program code) running in the computer device. The apparatus for performing encryption detection on communication data based on machine learning may be configured to perform some or all operations in the method embodiment shown in FIG. 2. With reference to FIG. 7, the apparatus for performing encryption detection on communication data based on machine learning may include units as follows:
an obtaining unit 701 configured to obtain the communication data; and
a processing unit 702 configured to perform a pre-analysis on a possibility that the communication data is encrypted data and obtain a pre-analysis result; call, when the pre-analysis result indicates that the possibility that the communication data is encrypted data is greater than a preset possibility threshold, a data encryption discriminative model to extract a data feature from the communication data; determine a discriminative feature library, the discriminative feature library including a plurality of prestored discriminative features; search for, based on a feature value of the data feature and a discriminative feature value of each prestored discriminative feature, in the discriminative feature library, a matching prestored discriminative feature of the data feature; and determine, when the matching prestored discriminative feature is found, that the communication data is encrypted data.

In an embodiment, the processing unit 702 is specifically configured to: obtain an information amount of the communication data, and determine information entropy of the communication data according to the information amount of the communication data, the information entropy being configured for indicating a level of complexity of the communication data, and the information entropy being in positive correlation to complexity of the communication data; and compare the information entropy with an entropy threshold, obtain a comparison result, perform a pre-analysis, based on the comparison result, on a possibility that the communication data is encrypted data, and obtain a pre-analysis result.

In an embodiment, information entropy corresponding to any piece of communication data after encryption is greater than information entropy corresponding to any piece of communication data before the encryption. If the comparison result indicates that the information entropy of the communication data is greater than or equal to the entropy threshold, the pre-analysis result indicates that the possibility that the communication data is encrypted data is greater than the preset possibility threshold. If the comparison result indicates that the information entropy of the communication data is less than the entropy threshold, the pre-analysis result indicates that a possibility that the communication data is unencrypted data is greater than the preset possibility threshold.

In an embodiment, the obtaining unit 701 is specifically configured to: obtain a communication data packet from a communication system, and extract, by a data analysis tool from the communication data packet, transmission data in the communication system; and perform preprocessing on the transmission data by the data analysis tool, and obtain the communication data. The communication data includes at least one type of: multimedia data, document data, database data, webpage data, and protocol data. The preprocessing includes at least one type of: data deduplication and data cleaning.

In an embodiment, the processing unit 702 is further configured to: obtain, when the communication data is determined to be encrypted data, current encryption strength of the communication data; compare the current encryption strength with a preset strength threshold, and obtain a comparison result; and recommend, if the comparison result indicates that the current encryption strength is less than the preset strength threshold, encryption strength matching security of the communication data. The encryption strength matching the security of the communication data is greater than the current encryption strength.

In an embodiment, the processing unit 702 is further configured to: determine directly, when the pre-analysis result indicates that the possibility that the communication data is unencrypted data is greater than the preset possibility threshold, that the communication data is unencrypted data; or determine, when no matching prestored discriminative feature is found, that the communication data is unencrypted data.

In an embodiment, the processing unit 702 is further configured to: generate, when the communication data is determined to be encrypted data, a first discrimination result of the communication data; and generate, when the communication data is determined to be unencrypted data, a second discrimination result of the communication data. The apparatus further includes an outputting unit 703 configured to: display an application interface, and display the first discrimination result or the second discrimination result on the application interface according to a target format. The target format includes one or more types of: an image, a text, a form, audio, and video.

In an embodiment, the outputting unit 703 is further configured to: display, if the first discrimination result is displayed on the application interface according to the target format, one or two of a current encryption method and the current encryption strength of the communication data on the application interface; and display, if the second discrimination result is displayed on the application interface according to the target format, one or two of a recommended encryption method and recommended encryption strength that match the security of the communication data on the application interface.

In an embodiment, the obtaining unit 701 is configured to: obtain a training sample set. The training sample set includes at least one piece of encrypted communication sample data and at least one piece of unencrypted communication sample data.

The processing unit 702 is configured to: extract a sample feature from each piece of encrypted communication sample data, and extract a sample feature from each piece of unencrypted communication sample data; and train an initial discriminative model according to the sample feature of each piece of encrypted communication sample data and the sample feature of each piece of unencrypted communication sample data, and obtain the data encryption discriminative model.

In an embodiment, one piece of encrypted communication sample data corresponds to one piece of unencrypted communication sample data. Any piece of encrypted communication sample data is obtained by encrypting corresponding unencrypted communication sample data. Any piece of communication sample data includes encrypted communication sample data or unencrypted communication sample data. The processing unit 702 is specifically configured to: perform a feature analysis on each piece of encrypted communication sample data, obtain an initial feature of each piece of encrypted communication sample data, perform a feature analysis on each piece of unencrypted communication sample data, and obtain an initial feature of each piece of unencrypted communication sample data; extract, according to a feature difference between an initial feature of the encrypted communication sample data and an initial feature of corresponding unencrypted communication sample data, a target feature from an initial feature of any piece of communication sample data, the target feature being configured for distinguishing the encrypted communication sample data from the corresponding unencrypted communication sample data; and perform dimension reduction on the target feature, and obtain the sample feature of any piece of communication sample data, a data dimension of the target feature after the dimension reduction being less than a data dimension of the target feature.

In an embodiment, if any piece of communication sample data in the training sample set carries a label, the processing unit 702 is specifically configured to: generate, according to a sample feature of each piece of communication sample data, a predicted label of corresponding communication sample data, and train the initial discriminative model by using a predicted label of each piece of communication sample data and a label of the corresponding communication sample data. If any piece of communication sample data in the training sample set has no label, the processing unit 702 is specifically configured to: perform, according to a sample feature of each piece of communication sample data, classification prediction on corresponding communication sample data, and train the initial discriminative model by using a classification prediction result.

In an embodiment, the discriminative feature library is obtained by performing feature extraction on the encrypted communication sample data, and the encrypted communication sample data is obtained by encrypting the corresponding unencrypted communication sample data through different encryption methods.

The unencrypted communication sample data includes one or more types of: analogue communication data, real communication data, standard communication data, and merged communication data.

The analogue communication data is obtained by calling an analogue communication system for communication simulation. The real communication data is obtained by calling a real communication system for real communication. The standard communication data is data that is randomly generated and satisfies a communication standard. The merged communication data is obtained by merging at least two pieces of existing unencrypted communication sample data.

In an embodiment, one prestored discriminative feature in the discriminative feature library corresponds to one encryption method. The processing unit 702 is specifically configured to: determine, when the matching prestored discriminative feature is found, that the communication data is obtained through an encryption method corresponding to the matching prestored discriminative feature, and determine that the communication data is encrypted data.

In an embodiment of this application, the communication data may be obtained. A pre-analysis is performed on a possibility that the communication data is encrypted data. A pre-analysis result is obtained. A level of the possibility that the communication data is encrypted data can be determined through the pre-analysis. Further, whether the communication data is encrypted data can be initially discriminated. When the pre-analysis result indicates that the possibility that the communication data is encrypted data is greater than a preset possibility threshold, a data encryption discriminative model may be called to extract a data feature from the communication data. Next, based on a feature value of the data feature and a feature value of each prestored discriminative feature, a matching prestored discriminative feature of the data feature may be searched for in the discriminative feature library. Moreover, when the matching prestored discriminative feature of the data feature is found, the communication data can be determined to be encrypted data. In the above processing process, the pre-analysis, data feature extraction, etc. may be sequentially performed on the possibility that the communication data is encrypted data. Then, matching is performed according to the feature value of the data feature and the feature value of the prestored discriminative feature. Finally, whether the communication data is encrypted is determined. In this way, a multi-dimensional analysis can be implemented on the communication data such that encrypted data can be relatively accurately determined. An accuracy rate of detecting whether the communication data is encrypted can be improved. Further, effectiveness of performing the encryption detection on the communication data can be improved. In a scenario of performing encryption detection on massive communication data, communication data having a relatively high encryption possibility is selected by determining an encryption possibility of the communication data. Then, in a case of the communication data having a relatively high encryption possibility, encrypted data is finally determined by a data encryption discriminative model. In this way, overall efficiency of detecting whether the communication data is encrypted can be improved, and effectiveness of the encryption detection can be ensured.

The computer device provided in an embodiment of this application will be stated next.

An embodiment of this application further provides a schematic structural diagram of a computer device. The schematic structural diagram of the computer device can be obtained with reference to FIG. 8. The computer device may include: a processor 801, an inputting device 802, an outputting device 803, and a memory 804. The processor 801, the inputting device 802, the outputting device 803, and the memory 804 mentioned above are connected by a bus. The memory 804 is configured to store a computer program. The computer program includes a program instruction. The processor 801 is configured to execute the program instruction stored in the memory 804.

In an embodiment, the computer device may be the computer device in the system shown in FIG. 1A. In the embodiment, the processor 801 performs, by running the executable program code in the memory 804, operations as follows: obtain the communication data, perform a pre-analysis on a possibility that the communication data is encrypted data, and obtain a pre-analysis result; call, when the pre-analysis result indicates that the possibility that the communication data is encrypted data is greater than a preset possibility threshold, a data encryption discriminative model to extract a data feature from the communication data; determine a discriminative feature library, the discriminative feature library including a plurality of prestored discriminative features; search for, based on a feature value of the data feature and a discriminative feature value of each prestored discriminative feature, in the discriminative feature library, a matching prestored discriminative feature of the data feature; and determine, when the matching prestored discriminative feature is found, that the communication data is encrypted data.

In an embodiment, the processor 801 is specifically configured to: obtain an information amount of the communication data, and determine information entropy of the communication data according to the information amount of the communication data, the information entropy being configured for indicating a level of complexity of the communication data, and the information entropy being in positive correlation to complexity of the communication data; and compare the information entropy with an entropy threshold, obtain a comparison result, perform a pre-analysis, based on the comparison result, on a possibility that the communication data is encrypted data, and obtain a pre-analysis result.

In an embodiment, information entropy corresponding to any piece of communication data after encryption is greater than information entropy corresponding to any piece of communication data before the encryption. If the comparison result indicates that the information entropy of the communication data is greater than or equal to the entropy threshold, the pre-analysis result indicates that the possibility that the communication data is encrypted data is greater than the preset possibility threshold. If the comparison result indicates that the information entropy of the communication data is less than the entropy threshold, the pre-analysis result indicates that a possibility that the communication data is unencrypted data is greater than the preset possibility threshold.

In an embodiment, the processor 801 is specifically configured to: obtain a communication data packet from a communication system, and extract, from the communication data packet, transmission data in the communication system; and perform preprocessing on the transmission data, and obtain the communication data. The transmission data is extracted and preprocessed by the same data analysis tool. The communication data includes at least one type of: multimedia data, document data, database data, webpage data, and protocol data. The preprocessing includes at least one type of: data deduplication and data cleaning.

In an embodiment, the processor 801 is further configured to: obtain, when the communication data is determined to be encrypted data, current encryption strength of the communication data; compare the current encryption strength with a preset strength threshold, and obtain a comparison result; and recommend, if the comparison result indicates that the current encryption strength is less than the preset strength threshold, encryption strength matching security of the communication data, the encryption strength matching the security of the communication data being greater than the current encryption strength.

In an embodiment, the processor 801 is further configured to: determine directly, when the pre-analysis result indicates that the possibility that the communication data is unencrypted data is greater than the preset possibility threshold, that the communication data is unencrypted data; or determine, when no matching prestored discriminative feature is found, that the communication data is unencrypted data.

In an embodiment, the processor 801 is further configured to: generate, when the communication data is determined to be encrypted data, a first discrimination result of the communication data; and generate, when the communication data is determined to be unencrypted data, a second discrimination result of the communication data. The processor 801 is configured to call the outputting device 803 to: display an application interface, and display the first discrimination result or the second discrimination result on the application interface according to a target format. The target format includes one or more types of: an image, a text, a form, audio, and video.

In an embodiment, the processor 801 is configured to call the outputting device 803 to: display, if the first discrimination result is displayed on the application interface according to the target format, one or two of a current encryption method and the current encryption strength of the communication data on the application interface; and display, if the second discrimination result is displayed on the application interface according to the target format, one or two of a recommended encryption method and recommended encryption strength that match the security of the communication data on the application interface.

In an embodiment, the processor 801 is configured to obtain a training sample set, the training sample set including at least one piece of encrypted communication sample data and at least one piece of unencrypted communication sample data; extract a sample feature from each piece of encrypted communication sample data, and extract a sample feature from each piece of unencrypted communication sample data; and train an initial discriminative model according to the sample feature of each piece of encrypted communication sample data and the sample feature of each piece of unencrypted communication sample data, and obtain the data encryption discriminative model.

In an embodiment, one piece of encrypted communication sample data corresponds to one piece of unencrypted communication sample data. Any piece of encrypted communication sample data is obtained by encrypting corresponding unencrypted communication sample data. Any piece of communication sample data includes encrypted communication sample data or unencrypted communication sample data. The processor 801 is specifically configured to: perform a feature analysis on each piece of encrypted communication sample data, obtain an initial feature of each piece of encrypted communication sample data, perform a feature analysis on each piece of unencrypted communication sample data, and obtain an initial feature of each piece of unencrypted communication sample data; extract, according to a feature difference between an initial feature of the encrypted communication sample data and an initial feature of corresponding unencrypted communication sample data, a target feature from an initial feature of any piece of communication sample data, the target feature being configured for distinguishing the encrypted communication sample data from the corresponding unencrypted communication sample data; and perform dimension reduction on the target feature, and obtain the sample feature of any piece of communication sample data, a data dimension of the target feature after the dimension reduction being less than a data dimension of the target feature.

In an embodiment, if any piece of communication sample data in the training sample set carries a label, the processor 801 is specifically configured to: generate, according to a sample feature of each piece of communication sample data, a predicted label of corresponding communication sample data, and train the initial discriminative model by using a predicted label of each piece of communication sample data and a label of the corresponding communication sample data. If any piece of communication sample data in the training sample set has no label, the processor 801 is specifically configured to: perform, according to a sample feature of each piece of communication sample data, classification prediction on corresponding communication sample data, and train the initial discriminative model by using a classification prediction result.

In an embodiment, the discriminative feature library is obtained by performing feature extraction on the encrypted communication sample data. The obtained encrypted communication sample data is obtained by encrypting the corresponding unencrypted communication sample data through different encryption methods.

The unencrypted communication sample data includes one or more types of: analogue communication data, real communication data, standard communication data, and merged communication data.

The analogue communication data is obtained by calling an analogue communication system for communication simulation. The real communication data is obtained by calling a real communication system for real communication. The standard communication data is data that is randomly generated and satisfies a communication standard. The merged communication data is obtained by merging at least two pieces of existing unencrypted communication sample data.

In an embodiment, the processor 801 is further configured to: obtain, when the communication data is determined to be encrypted data, current encryption strength of the communication data; compare the current encryption strength with a preset strength threshold, and obtain a comparison result; and recommend, if the comparison result indicates that the current encryption strength is less than the preset strength threshold, encryption strength matching security of the communication data. The encryption strength matching the security of the communication data is greater than the current encryption strength.

In an embodiment, one prestored discriminative feature in the discriminative feature library corresponds to one encryption method. The processor 801 is specifically configured to: determine, when the matching prestored discriminative feature is found, that the communication data is obtained through an encryption method corresponding to the matching prestored discriminative feature, and determine that the communication data is encrypted data.

In an embodiment of this application, the communication data may be obtained. A pre-analysis is performed on a possibility that the communication data is encrypted data. A pre-analysis result is obtained. A level of the possibility that the communication data is encrypted data can be determined through the pre-analysis. Further, whether the communication data is encrypted data can be initially determined. When the pre-analysis result indicates that the possibility that the communication data is encrypted data is greater than a preset possibility threshold, a data encryption discriminative model may be called to extract a data feature from the communication data. Next, based on a feature value of the data feature and a feature value of each prestored discriminative feature, a matching prestored discriminative feature of the data feature may be searched for in the discriminative feature library. Moreover, when the matching prestored discriminative feature of the data feature is found, the communication data can be determined to be encrypted data. In the above processing process, the pre-analysis, data feature extraction, etc. may be sequentially performed on the possibility that the communication data is encrypted data. Then, matching is performed according to the feature value of the data feature and the feature value of the prestored discriminative feature. Finally, whether the communication data is encrypted is determined. In this way, a multi-dimensional analysis can be implemented on the communication data such that encrypted data can be relatively accurately determined. An accuracy rate of detecting whether the communication data is encrypted can be improved. Further, effectiveness of performing the encryption detection on the communication data can be improved. In a scenario of performing encryption detection on massive communication data, communication data having a relatively high encryption possibility is selected by determining an encryption possibility of the communication data. Then, in a case of the communication data having a relatively high encryption possibility, encrypted data is finally determined by a data encryption discriminative model. In this way, overall efficiency of detecting whether the communication data is encrypted can be improved, and effectiveness of the encryption detection can be ensured.

In addition, an embodiment of this application further provides a computer-readable storage medium. The computer-readable storage medium has a computer program stored therein. The computer program includes a program instruction. When executing the above program instruction, the processor can perform the method in the embodiments corresponding to FIG. 2 and FIG. 3, which will not be repeated herein. Technical details that are not disclosed in the computer-readable storage medium embodiment of this application can be obtained with reference to the descriptions of the method embodiment of this application. As an example, the program instruction may be deployed on a computer device, or is executed on a plurality of computer devices located at the same position, or is executed on a plurality of computer devices that are distributed in a plurality of positions and interconnected by a communication network.

According to another aspect of this application, a computer program product is provided. The computer program product includes a computer program. The computer program is stored in a computer-readable storage medium. A processor of a computer device reads the computer program from the computer-readable storage medium. When executing the computer program, the processor causes the computer device to perform the method in the embodiments corresponding to FIG. 2 and FIG. 3, which will not be repeated herein.

A person of ordinary skill in the art can understand that all or some of the flows of the methods in the above embodiments may be implemented by a computer program instructing relevant hardware. The computer program may be stored in a computer-readable storage medium. When the program is executed, the flows of the above method embodiments may be implemented. The storage medium may be a magnetic disc, an optical disc, a read-only memory (ROM), a random access memory (RAM), etc.

The embodiments disclosed above are merely exemplary embodiments of this application, but are not intended to limit the scope of claims of this application. A person of ordinary skill in the art can understand all or some of the flows for implementing the above embodiments. Any equivalent variations made based on the claims of this application shall fall within the scope of this application.

What is claimed is:

1. An encryption detection method comprising:
performing a pre-analysis on a possibility of communication data being encrypted, to obtain a pre-analysis result;
calling, in response to the pre-analysis result indicating that the possibility is greater than a preset possibility threshold, a data encryption discriminative model to extract a data feature from the communication data;
searching in a discriminative feature library for a matching prestored discriminative feature that matches the data feature, based on a feature value of the data feature and discriminative feature values of a plurality of prestored discriminative features in the discriminative feature library; and
determining, in response to the matching prestored discriminative feature being found, that the communication data is encrypted.

2. The method according to claim 1, wherein performing the pre-analysis includes:
determining information entropy of the communication data according to information amount of the communication data;
comparing the information entropy with an entropy threshold, to obtain a comparison result; and
performing the pre-analysis based on the comparison result.

3. The method according to claim 2, wherein the pre-analysis result indicates that the possibility is:
greater than the preset possibility threshold in response to the comparison result indicating that the information entropy is greater than or equal to the entropy threshold; and
less than or equal to the preset possibility threshold in response to the comparison result indicating that the information entropy is less than the entropy threshold.

4. The method according to claim 1, further comprising:
obtaining a communication data packet from a communication system;
extracting, using a data analysis tool and from the communication data packet, transmission data of the communication system, the communication data including at least one of multimedia data, document data, database data, webpage data, or protocol data; and
performing preprocessing on the transmission data using the data analysis tool, to obtain the communication data, the preprocessing including at least one of data deduplication or data cleaning.

5. The method according to claim 1, further comprising:
obtaining, in response to the communication data being determined to be encrypted, current encryption strength of the communication data;
comparing the current encryption strength with a preset strength threshold, to obtain a comparison result; and
recommending, in response to the comparison result indicating that the current encryption strength is less than the preset strength threshold, encryption strength matching security of the communication data and greater than the current encryption strength.

6. The method according to claim 1, further comprising:
determining, in response to the pre-analysis result indicating that the possibility is less than or equal to the preset possibility threshold, that the communication data is unencrypted.

7. The method according to claim 1, further comprising:
determining, in response to no matching prestored discriminative feature being found, that the communication data is unencrypted.

8. The method according to claim 1, further comprising:
generating, in response to the communication data being determined to be encrypted, a first discrimination result, and generating, in response to the communication data being determined to be unencrypted, a second discrimination result; and
displaying the first discrimination result or the second discrimination result on an application interface according to a target format, the target format including one or more of an image, a text, a form, audio, and video.

9. The method according to claim 8, further comprising:
displaying, in response to the first discrimination result being displayed, one or two of a current encryption method and a current encryption strength of the communication data on the application interface; and
displaying, in response to the second discrimination result being displayed, one or two of a recommended encryption method and a recommended encryption strength that match security of the communication data on the application interface.

10. The method according to claim 1, further comprising:
obtaining a training sample set, the training sample set including a plurality of pieces of communication sample data each being a piece of encrypted communication sample data or a piece of unencrypted communication sample data;
obtaining a plurality of sample features each being extracted from one of the plurality of pieces of communication sample data; and
training an initial discriminative model according to the plurality of sample features, to obtain the data encryption discriminative model.

11. The method according to claim 10, wherein:
each piece of encrypted communication sample data in the training sample set corresponds to and is obtained by encrypting one piece of unencrypted communication sample data in the training sample set; and
obtaining the plurality of sample features includes:
performing feature analysis on the plurality of pieces of communication sample data to obtain a plurality of initial features; and
for one piece of communication sample data of the plurality of pieces of communication sample data:
extracting a target feature from the initial feature of the one piece of communication sample data according to a feature difference that is:
between the one piece of communication sample data and one piece of unencrypted communication sample data corresponding to the one piece of communication sample data in response to the one piece of communication sample data being encrypted, or
between the one piece of communication sample data and one piece of encrypted communication sample data corresponding to the one piece of communication sample data in response to the one piece of communication sample data being unencrypted; and
performing dimension reduction on the target feature, to obtain the sample feature of the one piece of communication sample data.

12. The method according to claim 10, wherein:
each piece of communication sample data in the training sample set carries a label; and
training the initial discriminative model includes:
generating, according to the sample feature of each piece of communication sample data, a predicted label of corresponding piece of communication sample data; and
training the initial discriminative model using the predicted label of each piece of communication sample data and the label of the corresponding piece of communication sample data.

13. The method according to claim 10, wherein:
none of the plurality of pieces of communication sample data in the training sample set carries a label; and
training the initial discriminative model includes:
performing classification prediction on the plurality of pieces of communication sample data according to the plurality of sample features, to obtain a classification prediction result; and
training the initial discriminative model using the classification prediction result.

14. The method according to claim 1, further comprising:
performing feature extraction on encrypted communication sample data to obtain the discriminative feature library, the encrypted communication sample data being obtained by encrypting corresponding unencrypted communication sample data;
wherein the unencrypted communication sample data includes one or more types of:
analogue communication data obtained by calling an analogue communication system for communication simulation,
real communication data obtained by calling a real communication system for real communication;
standard communication data randomly generated that satisfies a communication standard, and
merged communication data obtained by merging at least two pieces of existing unencrypted communication sample data.

15. The method according to claim 1, wherein determining that the communication data is encrypted includes:
determining that the communication data is obtained through an encryption method corresponding to the matching prestored discriminative feature, and determining that the communication data is encrypted.

16. A computer device comprising:
a processor; and
a non-transitory computer-readable storage medium storing a computer program that, when executed by the processor, causes the processor to:
perform a pre-analysis on a possibility of communication data being encrypted, to obtain a pre-analysis result;
call, in response to the pre-analysis result indicating that the possibility is greater than a preset possibility threshold, a data encryption discriminative model to extract a data feature from the communication data;
search in a discriminative feature library for a matching prestored discriminative feature that matches the data feature, based on a feature value of the data feature and discriminative feature values of a plurality of prestored discriminative features in the discriminative feature library; and
determine, in response to the matching prestored discriminative feature being found, that the communication data is encrypted.

17. The computer device according to claim 16, wherein the computer program, when executed by the processor, further causes the processor to, when performing the pre-analysis includes:
determine information entropy of the communication data according to information amount of the communication data;
compare the information entropy with an entropy threshold, to obtain a comparison result; and
perform the pre-analysis based on the comparison result.

18. The computer device according to claim 17, wherein the pre-analysis result indicates that the possibility is:
greater than the preset possibility threshold in response to the comparison result indicating that the information entropy is greater than or equal to the entropy threshold; and
less than or equal to the preset possibility threshold in response to the comparison result indicating that the information entropy is less than the entropy threshold.

19. The computer device according to claim 16, wherein the computer program, when executed by the processor, further causes the processor to:
obtain a communication data packet from a communication system;
extract, using a data analysis tool and from the communication data packet, transmission data of the communication system, the communication data including at least one of multimedia data, document data, database data, webpage data, or protocol data; and
perform preprocessing on the transmission data using the data analysis tool, to obtain the communication data, the preprocessing including at least one of data deduplication or data cleaning.

20. A non-transitory computer-readable storage medium storing a computer program stored that, when executed by a processor, causes the processor to:
perform a pre-analysis on a possibility of communication data being encrypted, to obtain a pre-analysis result;
call, in response to the pre-analysis result indicating that the possibility is greater than a preset possibility threshold, a data encryption discriminative model to extract a data feature from the communication data;
search in a discriminative feature library for a matching prestored discriminative feature that matches the data feature, based on a feature value of the data feature and discriminative feature values of a plurality of prestored discriminative features in the discriminative feature library; and
determine, in response to the matching prestored discriminative feature being found, that the communication data is encrypted.
